(19) United States
(12) Patent Application Publication
(10) Pub. No.: US 2025/0383910 A1
(43) Pub. Date: Dec. 18, 2025

(54) VIRTUAL BOOTSTRAP ENVIRONMENT FOR AN OVERLAY NETWORK

(71) Applicant: Oracle International Corporation, Redwood Shores, CA (US)

(72) Inventors: Scott Allan Deboy, Portland, OR (US); Michel Belleau, L'Ange-Gardien (CA)

(73) Assignee: Oracle International Corporation, Redwood Shores, CA (US)

(21) Appl. No.: 19/238,261

(22) Filed: Jun. 13, 2025

Related U.S. Application Data
(60) Provisional application No. 63/660,377, filed on Jun. 14, 2024.
(60) Provisional application No. 63/691,152, filed on Sep. 5, 2024.

(51) Int. Cl. G06F 9/455; H04L 61/4511

(52) U.S. Cl. CPC G06F 9/45558; H04L 61/4511; G06F 2009/4557; G06F 2009/45595

(57) ABSTRACT

Techniques are disclosed for building a scalable footprint data center using a virtual bootstrap environment. A computing system can implement a virtual bootstrap environment in a host region data center. The computing system can deploy a first service in the virtual bootstrap environment. The first service can have a dependency on a second service. The computing system can then deploy an instance of the second service in the virtual bootstrap environment. The instance of the second service can be configured to receive service traffic from the first service after the instance of the second service is deployed in the virtual bootstrap environment. The first service can be configured to send the service traffic to a corresponding instance of the second service in the host region prior to the instance of the second service being deployed in the virtual bootstrap environment.

This application claims priority to and the benefit of the following applications, the entire contents of which are hereby incorporated by reference in their entirety for all purposes:
1. U.S. Provisional Patent Application 63/660,377, filed on Jun. 14, 2024, entitled “DRCC ARCHITECTURE UPDATE”; and
2. U.S. Provisional Patent Application 63/691,152, filed on Sep. 5, 2024, entitled “DEVICE IMAGING FOR BUILDING PRE-FABRICATED SCALABLE FOOTPRINT DATA CENTERS.”

### BACKGROUND

Cloud service providers (CSPs) can offer computing infrastructure for customers using resources in several data centers. As cloud computing demand increases, CSPs can improve the availability of cloud resources by scaling the data centers. However, scaling can result in large data center footprints with a significant number of computing devices requiring a commensurate amount of resources to operate as well as reserving significant computing resources for the effective management of the cloud resources themselves.

### BRIEF SUMMARY

Embodiments described herein relate to cloud computing networks. More particularly, the present disclosure describes architectures, infrastructure, and related techniques for provisioning the computing devices of a scalable footprint data center at a Prefab factory. A typical Cloud Service Provider (CSP) may provide cloud services to one or more customers which may have one or more tenancies. Each customer and/or tenancy may have the ability to customize and configure the infrastructure provisioned to support their allocated cloud resources. To manage the infrastructure provisioning for multiple customers, the CSP may reserve computing resources within a data center to provide certain “core” services to both customers and to other services operated by the CSP. For example, services like compute, networking, block storage, object storage, identity and access management, and key management and secrets services are implemented within a “service enclave” of the data center. The service enclave may connect via a substrate network of computing devices (virtual machines and/or bare metal instances) hosted within the data center. The substrate network may be a part of the “underlay network” of the data center, which includes the physical network connecting bare metal devices, smart network interface cards (SmartNICs) of the computing devices, and networking infrastructure like top-of-rack switches. By contrast, CSP customers have infrastructure provisioned in an “overlay network” comprising one or more virtual cloud networks (VCNs) of virtualized environments to provide resources for the customer (e.g., compute, storage, etc.).

The service enclave exists on dedicated hardware within the data center. Because of this, the services hosted within the service enclave are difficult to scale. Whereas additional racks and servers can be implemented within the data center to expand the resources available to CSP customers, the dedicated computing resources for the service enclave are typically of a fixed size that depends on the largest predicted size of the data center. Expanding the service enclave can require a complicated addition of computing resources that may impact the availability of the core services to customers. Additionally, unused resources within the service enclave (e.g., if the service enclave is sized too large for the customer demand from the data center) cannot be easily made available to the customers, since the service enclave does not typically allow network access from the customer overlay network.

Even as the demand for cloud services grows, CSPs may want to deploy data centers to meet that demand that initially have the smallest physical footprint possible. Such a footprint can improve the ease of both deploying the physical components and configuring the initial infrastructure while still allowing the data center to scale to meet customer demand. In the scalable footprint, rather than dedicate a portion of the computing hardware to providing the service enclave, the “core services” that are hosted in the service enclave can instead be implemented in the overlay network. By doing so, the core services can be scaled as the data center footprint expands. The computing devices used to construct the scalable footprint data center can be homogenized, improving the initial configuration and easing the expansion of the footprint when additional, homogeneous devices are added. In addition, by eliminating the substrate network, flexible overlay network shapes are made available for both CSP core services and customers.

A prefab factory may be a facility dedicated to configuring computing devices, networking devices, and other physical resources of a data center environment for delivery to a destination site (e.g., a customer facility, etc.). Operations for building a data center environment can include bootstrapping (e.g., provisioning and/or deploying) resources (e.g., infrastructure components, artifacts, etc.) for any suitable number of services available from the data center environment when delivered to the destination. Once the physical resources have been configured at the prefab factory, they may be shipped to the destination site, installed at the destination data center, and have final configurations and other software resources deployed to the physical resources. A prefab factory can also be used to configure the computing devices of a scalable footprint data center. Because a scalable footprint data center can include component configurations that are not typically present in conventional data center environments, the techniques for building a scalable footprint data center in a prefab factory can be tailored to address the converged computing architecture of the scalable footprint data center components.

During bootstrapping operations for building a data center environment, a “virtual bootstrap environment” (ViBE) can be used to provision infrastructure and deploy resources, including services, to a scalable footprint data center environment. A ViBE refers to a virtual cloud network that is provisioned in the overlay of an existing region (e.g., a “host region”). Once provisioned, a ViBE is connected to the physical components of a region using a communication channel (e.g., a VPN). Certain services like a deployment orchestrator, a public key infrastructure (PKI) service, and the like can be provisioned in a ViBE. These services can provide the capabilities required to bring the hardware online, establish a chain of trust to the new region, and deploy the remaining services in the new region.

When using a ViBE to build a region for a scalable footprint data center, the services deployed to the ViBE can be configured to so that the deployment to the ViBE can occur in any suitable order with respect to dependencies of the services on other services in the host region or the ViBE. In addition, communication between services that have “scaled out” to the region being built, services in the ViBE, and services in the host region can be facilitated with suitable proxying, since the host region and the region being built may exist in separate realms.

Embodiments described herein relate to methods, systems, and computer-readable media for building a scalable footprint data center using a virtual bootstrap environment. A method for building a scalable footprint data center can include implementing, by a computing system, a virtual bootstrap environment in a host region data center. The method can also include deploying, by the computing system, a first service in the virtual bootstrap environment. The first service can have a dependency on a second service. The method can also include deploying, by the computing system, an instance of the second service in the virtual bootstrap environment. The instance of the second service can be configured to receive service traffic from the first service after the instance of the second service is deployed in the virtual bootstrap environment. The first service can be configured to send the service traffic to a corresponding instance of the second service in the host region prior to the instance of the second service being deployed in the virtual bootstrap environment.

Another embodiment is directed to a computing system including one or more processors and one or more memories storing computer-executable instructions that, when executed by the one or more processors, cause the computing system to perform the method described above.

Yet another embodiment is directed to a non-transitory computer-readable medium storing computer-executable instructions that, when executed by one or more processors of a distributed computing system, cause the computing system to perform the method described above. In addition, embodiments may be implemented by using a computer program product, comprising computer program/instructions which, when executed by a processor, cause the processor to perform any of the methods described in the disclosure.

### BRIEF DESCRIPTION OF DRAWINGS

FIG. 1 is a block diagram illustrating the consolidation of computing resources in a scalable footprint data center, according to some embodiments.

FIG. 2 is a block diagram showing the configuration of a hyperconverged server rack for use in a scalable footprint data center, according to some embodiments.

FIG. 3 is a block diagram illustrating an example architecture of a scalable footprint data center in small, medium, and large footprints, according to some embodiments.

FIG. 4 is a diagram illustrating an example scalable footprint data center, according to some embodiments.

FIG. 5 is a block diagram illustrating an example physical networking architecture for a scalable footprint data center, according to some embodiments.

FIG. 6 is a block diagram illustrating an example architecture for networking in a scalable footprint data center, according to some embodiments.

FIG. 7 is a block diagram illustrating example applications that can be provided from a scalable footprint data center, according to some embodiments.

FIG. 8 is a block diagram illustrating a BIOS server architecture in a scalable footprint data center, according to some embodiments.

FIG. 9 is a block diagram of an environment in which a Cloud Infrastructure Orchestration Service (CIOS) may operate to dynamically provide bootstrap services in a region, according to at least one embodiment.

FIG. 10 is a block diagram for illustrating an environment and method for building a virtual bootstrap environment (ViBE), according to at least one embodiment.

FIG. 11 is a block diagram for illustrating an environment and method for bootstrapping services to a target region utilizing the ViBE, according to at least one embodiment.

FIG. 12 is a block diagram depicting an example set of services deployed in a ViBE for building a region of a scalable footprint data center, according to some embodiments.

FIG. 13 is a block diagram depicting a deployment order of services in a ViBE, according to some embodiments.

FIG. 14 is a block diagram depicting cross-realm communications in a ViBE, according to some embodiments.

FIG. 15 is a flow diagram of an example process for deploying services to a ViBE, according to some embodiments.

FIG. 16 is a flow diagram of an example process for enabling cross-realm traffic between a host region, a ViBE, and a region of a scalable footprint data center, according to some embodiments.

FIG. 17 is a block diagram illustrating an example computer system, according to at least one embodiment.

### DETAILED DESCRIPTION

### Scalable Footprint Data Center (Butterfly) Architecture

The adoption of cloud services has seen a rapid uptick in recent times. Various types of cloud services are now provided by various different cloud service providers (CSPs). The term cloud service is generally used to refer to a service or functionality that is made available by a CSP to users or customers on demand (e.g., via a subscription model) using systems and infrastructure (cloud infrastructure) provided by the CSP. Typically, the servers and systems that make up the CSP's infrastructure and which is used to provide a cloud service to a customer are separate from the customer's own on-premises servers and systems. Customers can thus avail themselves of cloud services provided by the CSP without having to purchase separate hardware and software resources for the services. Cloud services are designed to provide a subscribing customer easy, scalable, and on-demand access to applications and computing resources without the customer having to invest in procuring the infrastructure that is used for providing the services or functions. Various different types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

As indicated above, a CSP is responsible for providing the infrastructure and resources that are used for providing cloud services to subscribing customers. The resources provided by the CSP can include both hardware and software resources. These resources can include, for example, compute resources (e.g., virtual machines, containers, applications, processors), memory resources (e.g., databases, data stores), networking resources (e.g., routers, host machines, load balancers), identity, and other resources. In certain implementations, the resources provided by a CSP for providing a set of cloud services CSP are organized into data centers. A data center may be configured to provide a particular set of cloud services. The CSP is responsible for equipping the data center with infrastructure and resources that are used to provide that particular set of cloud services. A CSP may build one or more data centers.

A scalable footprint data center can have a new architecture for a region in which the initial network footprint is as small as feasible (e.g., six racks, four racks, and possibly even a single rack of server devices) while still providing core cloud services and scalability for customer demands. In particular, a scalable footprint data center may not segregate resources used for cloud services of the CSP from the resources available for the customer's applications. Instead, the scalable footprint data center can place core CSP services like Block Storage, Object Storage, Identity, Key Management, and Secrets, which operate in a Substrate Network in a conventional data center environment, into an Overlay network. This means that a scalable footprint data center may not have dedicated hosts for the Substrate Network. Such an architectural change can require particular solutions for connectivity between CSP services that now operate in the Overlay network. In addition, a small portion of fundamental boot services may be provided to ensure initial route configuration for the services in the Overlay during startup and/or recovery. However, the convergence of both CSP infrastructure resources and customer infrastructure resources can allow the scalable footprint data center to maximize the allocation of resources for both cloud services and customer applications while enabling efficient expansion and scaling of the data center as customer needs grow.

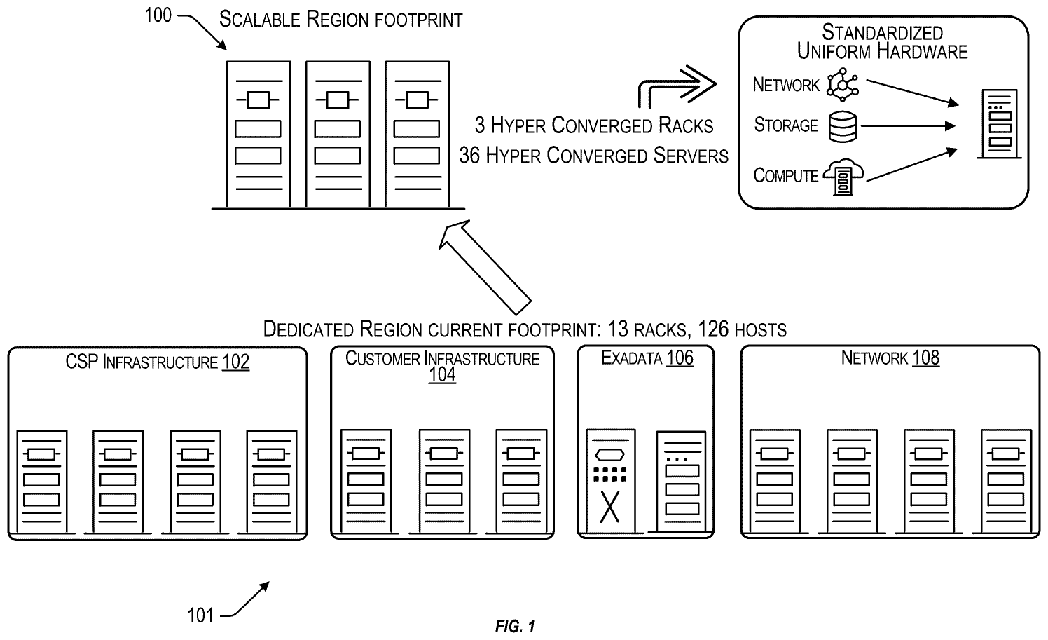

FIG. 1 is a block diagram illustrating the consolidation of computing resources in a scalable footprint data center 100, according to some embodiments. The scalable footprint data center 100 can be a data center forming a region or “region network.” A “region” is a logical abstraction of computing, networking, and storage resources of one or more data centers providing a cloud environment corresponding to a particular geographic region. FIG. 1 also shows a conventional data center 101 for providing cloud resources to customers of the region.

In a conventional data center 101, the plurality of server racks can each include multiple server devices as well as networking equipment (e.g., top of rack switches) and power supply and distribution equipment. The conventional data center 101 can have a standard footprint of 13 server racks as shown, with 126 bare metal host server devices, although additional server racks are possible in larger data centers.

To provide networking isolation between customer data and CSP data for CSP services executing in the conventional data center 101, a portion of the server racks can be reserved as a service enclave, so that the computing devices on those server racks can host and provide CSP services within the conventional data center 101 without also hosting customer data. As shown in FIG. 1, CSP infrastructure 102 and customer infrastructure 104 are separate, reserving a certain number of server racks (e.g., 4 racks) for CSP services and a certain number of server racks (e.g., 3 racks) for customer applications and data. The CSP infrastructure 102 can constitute the service enclave, while customer infrastructure 104 can form a portion of the customer enclave.

The isolation between the service enclave and the customer enclave can be enforced by software-defined perimeters that define edge devices and/or software within the enclave as distinguished from hardware/software elements outside of the enclave. Access into and out of each enclave may be controlled, monitored, and/or policy driven. For example, access to the service enclave may be based on authorization, limited to authorized clients of the CSP. Such access may be based on one or more credentials provided to the enclave.

The conventional data center 101 can also include Exadata database racks 106 and networking racks 108. The database racks 106 can include computing devices and storage devices that provide storage and management for databases, data stores, object storage, and similar data persistence techniques within the conventional data center 101. The networking racks 108 can include networking devices that provide connectivity to the computing devices within conventional data center 101 and to other networks (e.g., customer networks, the internet, etc.).

Unlike the conventional data center 101, in which particular server racks are reserved as CSP infrastructure 102 and customer infrastructure 104, the scalable footprint data center 100 can consolidate the network, storage, and compute resources that are separate in the conventional data center 101 into converged server racks. To meet the desired “as small as feasible” footprint, a new scalable footprint rack design can be used, including next-generation server devices referred to as “hyperconverged servers” that are configured to have the highest possible resource density and security capabilities for enabling substrate services in the overlay network. For example, a “hyperconverged” server device can include 2×192 core processors, 24×256 GB DDR5 RAM modules, 14×15.6 TB NVMe drives, a smart network interface card (SmartNIC), and a trusted platform module (TPM). The server racks that include hyperconverged server devices can then be referred to as “hyperconverged racks” or “scalable footprint racks.” The scalable footprint racks can have a standardized shape. For example, a “low density” configuration of a hyperconverged server rack can include six hyperconverged servers, while a “high density” configuration can include 12 hyperconverged servers. The new server architecture can allow for deployment of a scalable footprint data center having only a single rack hosting the core CSP services while still providing cloud resources to the customer. The initial footprint can then be scaled out as customer needs increase. In a typical configuration, a scalable footprint data center 100 can include three hyperconverged server racks for a total of 36 hyperconverged server devices providing all of the network, storage, and compute capabilities of a region network.

The following definitions are useful for portions of a scalable footprint data center built by a CSP:

Underlay network—The physical network that sits below the overlay network and virtual cloud networks (VCNs) therein. In a conventional data center 101, the existing Substrate network hosting the CSP services is a portion of the underlay network. ILOM ports, management and SmartNIC substrate addresses are also part of the underlay network.

Overlay network—The network environment that is available for use by executing services and applications, including virtualization environments, that provide the functionality of the data center to both customers and the CSP. The overlay network can include VCN(s), virtualization environments, and networking connections from these VCNs in the scalable footprint data center to other cloud computing services of the CSP (e.g., services provided in other data center environments).

Substrate network—A portion of the underlay network that contains host devices (e.g., bare metal computing devices and/or VMs) running only Substrate services. In existing environments these host devices may not have SmartNICs. The host devices may be managed by service teams responsible for one or more of the substrate services.

Substrate Services—The list of services that run in the Substrate network of a conventional data center 101. While most of these run in a service enclave (e.g., CSP infrastructure 102), some substrate service live outside of the service enclave. The substrate services have a mix of services that may communicate to the underlay network (e.g. Network Monitoring) and services that are hosted in the service enclave (e.g. Object Storage).

SmartNIC—A computing component that combines a network interface card with additional functionality for network virtualization to create layers of network abstraction that can be run on top of the physical networking components (e.g., the underlay network). The SmartNIC can include processors and memory that can perform computing operations to provide the additional functionality. In the conventional data center 101, host devices of the CSP infrastructure 102 do not include a SmartNIC, while host devices of the customer infrastructure 104 do include a SmartNIC. In the scalable footprint data center 100, all hyperconverged server devices will include a SmartNIC.

Integrated lights out managers (ILOMs)—An ILOM can be a processor or processing platform integrated with bare metal hosts in a data center that can provide functionality for managing and monitoring the hosts remotely in cases where the general functionality of the host may be impaired (e.g., fault occurrence).

Trusted Platform Module—a microcontroller or other processor (or multiple processors) along with storage for performing cryptographical operations like hashing, encryption/decryption, key and key pair generation, and key storage. The TPM may generally conform to a standard characterizing such devices, for example, ISO/IEC 11889. Each server device and BIOS device in a scalable footprint data center can include a TPM.

BIOS Device—A computing device or a plurality of computing devices on a server rack in the scalable footprint data center. The BIOS device may be designed to enable independent and resilient operations during various boot scenarios and network disruptions. The BIOS device may be configured to facilitate the initial boot processes for the scalable footprint data center, provide essential services during recovery, and ensure the region's stability, especially in power-constrained environments. The BIOS device hosts a range of functions, all of which can allow the autonomous operation of the region. For example, these functions can include DNS resolution, NTP synchronization, DHCP/ZTP configuration, and various security and provisioning services. By offering these capabilities, the BIOS device ensures that the rack can bootstrap itself, recover from power or network-related events, and maintain essential connectivity and management functions without relying on external resources. In various embodiments, the BIOS device can have similar hardware specifications (e.g., number of processors, amount of memory, amount of attached storage devices) as other server devices on the rack. In some instances, the functionality of the BIOS device may be provided by a computer-readable media that stores instructions that can be executed by a computer to implement the BIOS services. The BIOS device may not have a SmartNIC while other bare metal host devices in the rack do have a SmartNIC.

The following definitions are useful in the context of building region data centers in a prefab factory environment.

A “region” is a logical abstraction corresponding to a collection of computing, storage, and networking resources associated with a geographical location. A region can include any suitable number of one or more execution targets. A region may be associated with one or more data centers. A “prefab region” describes a region built in a prefab factory environment prior to delivery to the corresponding geographical location. A “Butterfly region” refers to a region for a scalable footprint data center, in which the initial computing components like server racks occupy In some embodiments, an execution target could correspond to the destination data center as opposed to the prefab factory data center.

An “execution target” refers to a smallest unit of change for executing a release. A “release” refers to a representation of an intent to orchestrate a specific change to a service (e.g., deploy version 8, “add an internal DNS record,” etc.). For most services, an execution target represents an “instance” of a service or an instance of change to be applied to a service. A single service can be bootstrapped to each of one or more execution targets. An execution target may be associated with a set of devices (e.g., a data center).

“Bootstrapping” a single service is intended to refer to the collective tasks associated with provisioning and deployment of any suitable number of resources (e.g., infrastructure components, artifacts, etc.) corresponding to a single service. Bootstrapping a region is intended to refer to the collective of tasks associated with each of the bootstrap of each of the services intended to be in the region.

A “service” refers to functionality provided by a set of resources, typically in the form of an API that customers can invoke to achieve some useful outcome. A set of resources for a service includes any suitable combination of infrastructure, platform, or software (e.g., an application) hosted by a cloud provider that can be configured to provide the functionality of a service. A service can be made available to users through the Internet.

An “artifact” refers to code being deployed to an infrastructure component or a Kubernetes engine cluster, this may include software (e.g., an application), configuration information (e.g., a configuration file), credentials, for an infrastructure component, or the like.

A “flock config” refers to a configuration file (or a set of configuration files) that describes a set of all resources (e.g., infrastructure components and artifacts) associated with a single service. A flock config may include declarative statements that specify one or more aspects corresponding to a desired state of the resources of the service.

“Service state” refers to a point-in-time snapshot of every resource (e.g., infrastructure resources, artifacts, etc.) associated with the service. The service state indicates status corresponding to provisioning and/or deployment tasks associated with service resources.

IaaS provisioning (or “provisioning”) refers to acquiring computers or virtual hosts for use, and even installing needed libraries or services on them. The phrase “provisioning a device” refers to evolving a device to a state in which it can be utilized by an end-user for their specific use. A device that has undergone the provisioning process may be referred to as a “provisioned device.” Preparing the provisioned device (installing libraries and daemons) may be part of provisioning; this preparation is different from deploying new applications or new versions of an application onto the prepared device. In most cases, deployment does not include provisioning, and the provisioning may need to be performed first. Once prepared, the device may be referred to as “an infrastructure component.”

IaaS deployment (or “deployment”) refers to the process of providing and/or installing a new application, or a new version of an application, onto a provisioned infrastructure component. Once the infrastructure component has been provisioned (e.g., acquired, assigned, prepared, etc.), additional software may be deployed (e.g., provided to and installed on the infrastructure component). The infrastructure component can be referred to as a “resource” or “software resource” after provisioning and deployment has concluded. Examples of resources may include, but are not limited to, virtual machines, databases, object storage, block storage, load balancers, and the like.

A “virtual bootstrap environment” (ViBE) refers to a virtual cloud network that is provisioned in the overlay network of an existing region (e.g., a “host region”). Once provisioned, a ViBE is connected to a new region using a communication channel (e.g., an IPSec Tunnel VPN). Certain essential core services (or “seed” services) like a deployment orchestrator, a public key infrastructure (PKI) service, a dynamic host configuration protocol service (DHCP), a domain name service (DNS), and the like can be provisioned in a ViBE. These services can provide the capabilities required to bring the hardware online, establish a chain of trust to the new region, and deploy the remaining services in the new region. Utilizing the virtual bootstrap environment can prevent circular dependencies between bootstrapping resources by utilizing resources of the host region. These services can be staged and tested in the ViBE prior to the prefab region (e.g., the target region) being available.

A “capability” identifies a unit of functionality associated with a service. The unit could be a portion, or all, of the functionality to be provided by the service. By way of example, a capability can be published indicating that a resource is available for authorization/authentication processing (e.g., a subset of the functionality to be provided by the resource). As another example, a capability can be published indicating the full functionality of the service is available. Capabilities can be used to identify functionality on which a resource or service depends and/or functionality of a resource or service that is available for use.

A “Cloud Infrastructure Orchestration Service” (CIOS) may refer to a system configured to manage provisioning and deployment operations for any suitable number of services as part of a region build.

A Multi-Flock Orchestrator (MFO) may be a computing component (e.g., a service) that coordinates events between components of the CIOS to provision and deploy services to a target region (e.g., a new region). An MFO tracks relevant events for each service of the region build and takes actions in response to those events.

A “host region” refers to a region that hosts a virtual bootstrap environment (ViBE). A host region may be used to bootstrap a ViBE.

A “target region” refers to a region under build.

“Publishing a capability” refers to “publishing” as used in a “publisher-subscriber” computing design or otherwise providing an indication that a particular capability is available (or unavailable). The capabilities are “published” (e.g., collected by a capabilities service, provided to a capabilities service, pushed, pulled, etc.) to provide an indication that functionality of a resource/service is available. In some embodiments, capabilities may be published/transmitted via an event, a notification, a data transmission, a function call, an API call, or the like. An event (or other notification/data transmission/etc.) indicating availability of a particular capability can be broadcasted/addressed (e.g., published) to a capabilities service.

A “Capabilities Service” may be a flock configured to model dependencies between different flocks. A capabilities service may be provided within a Cloud Infrastructure Orchestration Service and may define what capabilities, services, features have been made available in a region.

A “Real-time Regional Data Distributor” (RRDD) may be a service or system configured to manage region data. This region data can be injected into flock configs to dynamically create execution targets for new regions.

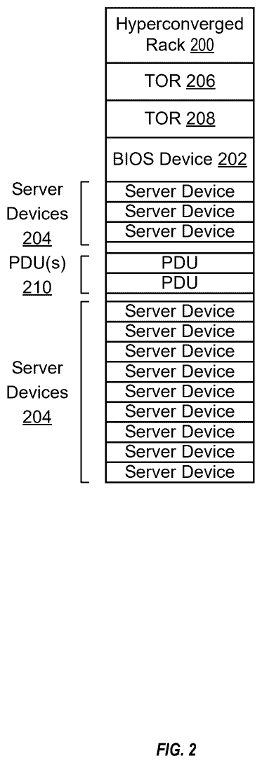

FIG. 2 is a block diagram showing the configuration of a hyperconverged server rack 200 for use in a scalable footprint data center, according to some embodiments. In some embodiments, the hyperconverged server rack 200 can be a standard 42 U size server rack. As shown in FIG. 2, hyperconverged server rack 200 can include two TORs, TOR 206 and TOR 208. The hyperconverged server rack 200 can also include BIOS device 202, which can be a server device used for initialization operations in the scalable footprint data center and two power distribution units (PDUs) 210.

The hyperconverged server rack 200 can include server devices 204. As depicted in FIG. 2, the hyperconverged server rack 200 can be a high-density configuration including 12 server device 204. In some embodiments, the hyperconverged server rack 200 can be a low-density configuration with six server devices. The server devices 204 can be hyperconverged server devices as described above, including two 192 core processors, 24 256 GB DDR5 RAM modules (for 6 TB total memory), a SmartNIC supporting two 100G uplinks, a host NIC also supporting two 100G uplinks, two 960 GB m.2 NVMe boot drives, 14 15.6 TB NVMe storage drives, and a TPM. However, one skilled in the art would appreciate that server devices having even greater computing resource density are possible in the server racks described herein. The PDUs 210 for hyperconverged server rack 200 may be configured to provide sufficient power to the server devices 204 on the hyperconverged server rack 200.

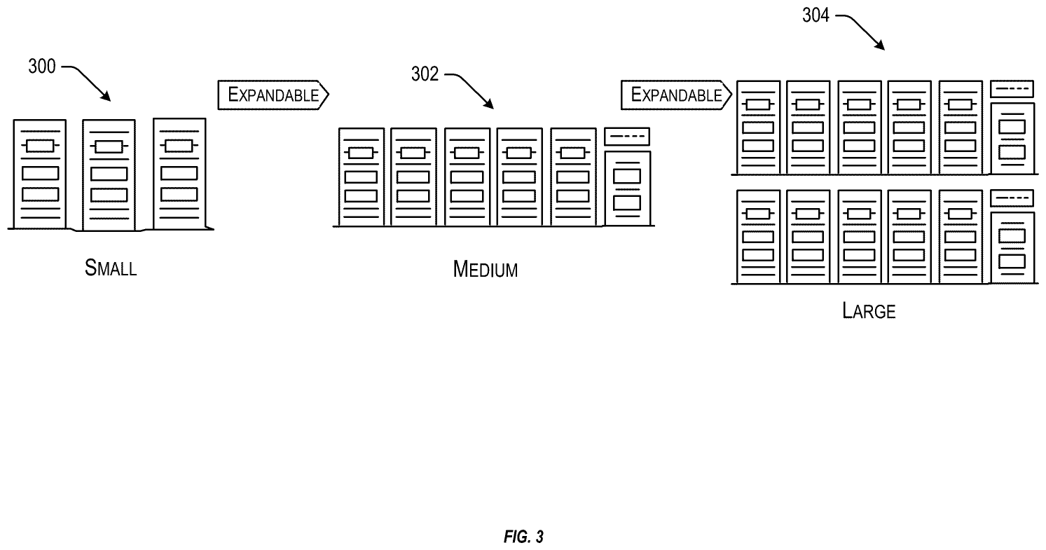

FIG. 3 is a block diagram illustrating an example architecture of a scalable footprint data center in small, medium, and large footprints, according to some embodiments. An initial deployment of infrastructure components for a scalable footprint data center can include three server racks (e.g., three hyperconverged server racks 200 of FIG. 2). From there, the scalable footprint data center can be expanded to provide additional resources for customer applications (and CSP services) in the region. Each of the three footprints for a scalable footprint data center are described below.

Small Footprint 300—A small footprint 300 can begin with three scalable footprint racks. Additional scalable footprint racks can be added to the small footprint 300. Depending on the configuration of the rack (e.g., high-density or low-density), up to six high density scalable footprint racks or up to 12 low density scalable footprint racks can be included in the small footprint 300. Each additional scalable footprint rack can be connected to the existing footprint in a ring network using the TOR switches on each rack. Because the service control planes are functional in the overlay of the initial scalable footprint rack, the additional racks can be adapted to provide additional data plane resources for those services. Each scalable footprint rack can support connections to the customer's network. In some embodiments, the small footprint can include as few as one scalable footprint rack.

Medium Footprint 302—From a small footprint 300, the scalable footprint data center can have additional racks added. To support racks beyond the upper capacity of the small footprint 300, a new networking rack can be connected to the existing scalable footprint data center and then connected to the additional racks. In some embodiments, the additional racks can be conventional racks rather than scalable footprint racks. For example, the additional racks can be conventional racks that use server devices other than the hyperconverged server devices described herein. The ring network of the small footprint 300 can be preserved even with the connection to the networking rack. In some embodiments, the networking rack can support connections to 64 total racks (inclusive of the scalable footprint racks) and can provide the connection to the customer's network. Example specifications for the networking rack include two chasses that each have 4 LCs each with 24×400G ports for a total of 384×100G links, 8×100G connections to each server rack (up to 64 racks), up to 128×100G towards the customer network, and up to 128×100G available for future expansion.

Large Footprint 304—From the medium footprint 302, the scalable footprint data center can have additional capacity beyond 64 total racks added. The large footprint 304 may require adding an optical gate rack for connecting additional racks beyond the 64 rack limit. The additional racks of the large footprint 304 can include racks (e.g., QFab) supporting Exadata (e.g., Exadata 106 of FIG. 1) or other high-capacity, high-throughput data service. Within the large footprint 304, the original scalable footprint racks of the small footprint 300 can continue to provide the core services of the CSP.

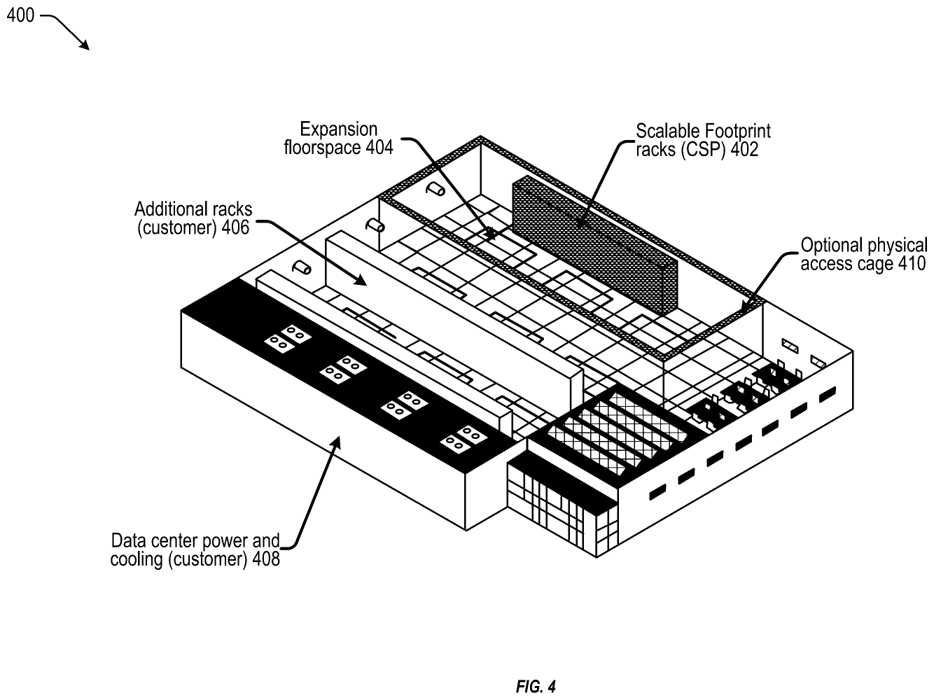

FIG. 4 is a diagram illustrating an example scalable footprint data center 400, according to some embodiments. The scalable footprint data center 400 can be a facility for hosting the components of a scalable footprint region, including the small footprint 300, medium footprint 302, and large footprint 304 of FIG. 3. The scalable footprint data center 400 can be a facility operated by a customer of the CSP. For example, the customer may desire having cloud services of the CSP available and sited close to the on-premises computing infrastructure of the customer to improve speed and network connectivity. The CSP can then deploy the scalable footprint racks within the scalable footprint data center 400. In some embodiments, the scalable footprint data center 400 can be a data center operated by the CSP, with no distinction between CSP and customer components as described below.

The scalable footprint data center 400 can include scalable footprint racks 402. The scalable footprint racks 402 can be examples of the scalable footprint racks described above, including the hyperconverged server rack 200 of FIG. 2. For example, the scalable footprint racks 402 can be a rack for a small footprint (e.g., small footprint 300 of FIG. 3) initial deployment at the scalable footprint data center 400. The scalable footprint data center 400 can include expansion floorspace 404 that can accommodate the expansion of the scalable footprint racks 402. For example, as a small footprint expands to a medium footprint, the additional server racks can be installed in the expansion floorspace 404. In some embodiments, the server racks providing CSP services can be protected by an optional physical access cage 410. However, data security features that are enabled for the hyperconverged architecture of the scalable footprint racks can allow the physical access cage 410 to be omitted even in customer-controlled scalable footprint data centers.

The scalable footprint data center 400 can also include additional racks 406 that provided computing resources of a customer's on-premises network. In embodiments where the scalable footprint data center 400 is operated by the CSP, the additional racks 406 may be server racks for scaling the footprint to a large footprint (e.g., large footprint 304 of FIG. 3). The scalable footprint data center 400 can also include power and cooling 408. The power and cooling can be sufficient for the number of racks for both the scalable footprint region and/or the customer's on-premises network.

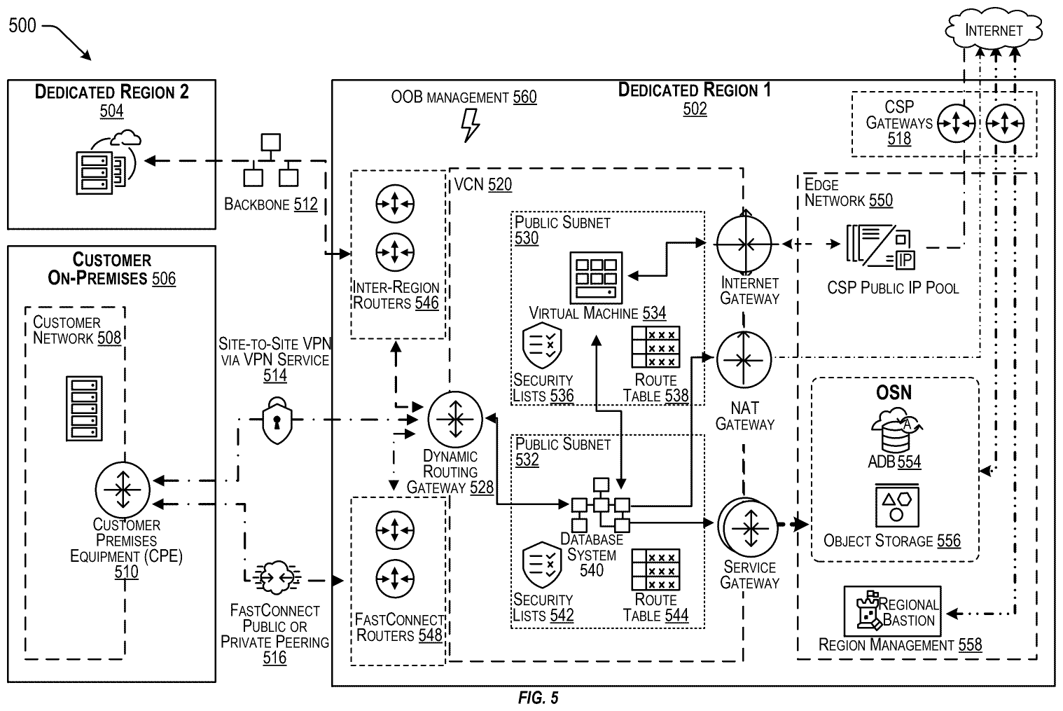

FIG. 5 is a block diagram illustrating an example physical networking infrastructure 500 for regions including scalable footprint data centers, according to some embodiments. A dedicated region 502 can be configured to provide infrastructure for hosting CSP services and/or customer applications according to the patterns described herein. The pattern for networking infrastructure 500 depicted in FIG. 5 can include connections to other dedicated regions (e.g., dedicated region 504), customer on-premises computing resources 506, and other cloud services of the CSP. Connections to another dedicated region 504 can be via a backbone 512 network connection, which can include backbone internet connections between data centers hosting the dedicated region 502 and the dedicated region 504. Connections to customer on-premises infrastructure 506 can be via site-to-site VPN 514 or a private physical network connection like FastConnect 516, which can be implemented using either public or private peering. The site-to-site VPN 514 can be provided by a VPN service which can be hosted in the dedicated region 502 or by the CSP in another cloud environment. Connections to the cloud from the dedicated region 502 can be via CSP gateways 518. The customer on-premises infrastructure 506 can include the customer network 508, connecting with customer-controlled computing resources including additional server racks (e.g., additional racks 406 of FIG. 4). The customer's on premises infrastructure 506 can be accessed via gateways of the customer premises equipment 510.

In some examples, the dedicated region 502 can connect to the CSP services via the Internet using CSP gateways 518. The CSP can provide operational support (e.g., monitoring, network management, etc.) for the dedicated region 502 using the same network connection. Connectivity between the dedicated region 502 and the CSP can be implemented via direct network peering to the CSP gateways 518. In some examples, the CSP gateways 518 can provide always-on distributed denial of service (DDoS) detection and mitigation for common layer 3 and 4 volumetric DDOS attacks, such as SYN, UDP, and ICMP floods and NTP amplification attacks. In some embodiments, the CSP gateways 518 can be provided in the point of presence (POP) associated with the scalable footprint data center. In some embodiments, the CSP gateways can be provided in the dedicated region 502 to enable direct peering.

In some examples, the dedicated region 502 can connect to another dedicated region 504 via the backbone 512. The backbone 512 can act as a public peering path between dedicated region 502 and dedicated region 504. The backbone 512 can also act as a private peering path between VCNs across regions. For example, VCN 520 can be peered with a VCN within dedicated region 504. In some examples, peering links between dedicated region 502 and dedicated region 504 can be used to setup disaster recovery operations between the regions. The backbone 512 can use redundant and diverse networking paths from different service providers (e.g., ISPs). The backbone 512 can provide suitable bandwidth to support the connectivity of dedicated regions. For example, the backbone 512 can provide one or more 10 or 100 Gbps links. In some examples, traffic (e.g., layer 2 traffic) over the backbone 512 can be encrypted using a security protocol (e.g., MACsec). The CSP can manage encapsulation and isolation of traffic over the backbone 512 for different tenancies (e.g., different customers) in both dedicated region 502 and dedicated region 504. Routing between the dedicated regions can be enabled by inter-region routers 546.

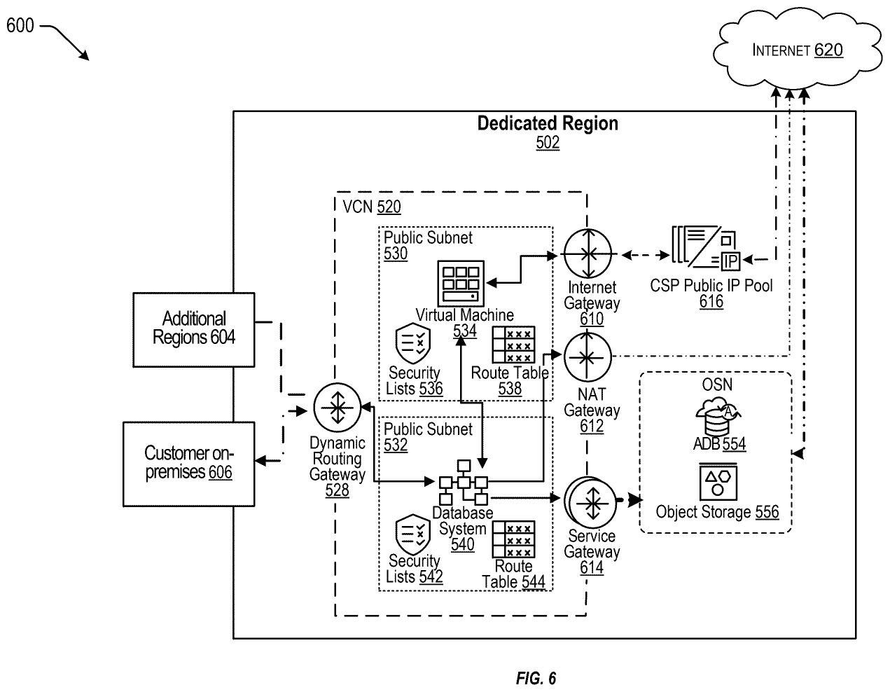

In some examples, the dedicated region 502 can be connected to the customer's on-premises infrastructure 506 using a site-to-site VPN 514 or a private physical connection like FastConnect 516. The private physical connection can be provided by the CSP via provided hardware including FastConnect routers 548. The connection between the dedicated region 502 and the on-premises infrastructure 506 can used to migrate applications from the on-premises infrastructure 506 to the dedicated region 502. For example, a customer operating its own data center can implement a scalable footprint region in the data center (e.g., scalable footprint data center 400 of FIG. 4) to expand the capabilities and functionality of the cloud resources. As part of the implementation, applications that were previously hosted on customer on-premises infrastructure 506 can be moved to customer infrastructure in the overlay network of the dedicated region 502. In some examples, the customer on-premises infrastructure 506 can be used to split compute workloads between the customer network 508 and the dedicated region 502. Border gateway protocol (BGP) routing can advertise VCN CIDR routes or a subset of routes between the customer on-premises infrastructure 506 and the dedicated region 502 via a dynamic routing gateway (DRG) 528 and FastConnect routers 548. Details of the DRG 528, as well as the other virtual networking components like the internet gateway, network address translation (NAT) gateway, and the service gateway that are accessible from VCN 520, are provided below with respect to FIG. 6.

In the scalable footprint data center, CSP services and customer applications can execute in one or more VCNs, including VCN 520. The VCN 520 can exist in the Overlay network. The Overlay network can include additional VCNs not depicted in FIG. 5.

The VCN 520 can include multiple subnets, including public subnet 530 and public subnet 532. For example, public subnet 530 can include virtual machine (VM) 534, which can be configured to host processes and applications for performing compute operations in the dedicated region 502. The public subnet 530 can have security lists 536 defining security rules for ingress and egress traffic to/from the endpoints of the public subnet 530. The public subnet 530 can also include a route table 538 that includes known routes to endpoints within the dedicated region 502.

Similarly, public subnet 532 can include security lists 542 that define security rules for ingress and egress traffic to/from the public subnet 532. The security list 542 can define different security rules than security lists 536. The public subnet can have a route table 544 that includes the known routes to endpoints within the dedicated region 502. The public subnet 532 can include a database system 540. The database system 540 can be configured to provide data persistence and retrieval. For example, VM 534 can use database system 540 to persist data generated by VM 534. Database system 540 can connect to storage devices of the hyperconverged server devices that provide database storage. For example, the CSP service network can include autonomous database service 554 and object storage service 556 that provide data storage capabilities within the dedicated region 502. In some examples, the service network can be in an edge network 550 of the dedicated region 502.

In addition, to the components described above, the underlay network of the dedicated region 502 can include various devices and other networking endpoints that are connected via the physical networking components of the scalable footprint data center. The underlay network can include, without limitation, ILOM(s), Bastions (e.g., region management bastion 558), NTP server(s) (e.g., NTP service provided on a BIOS device), BIOS services, and VNIC(s). The ILOM(s) can be computing devices and network targets that provide access to the server devices of the dedicated region 502 for both in-band and out-of-band management. For example, the ILOM(s) can allow for remote management of the associated server devices within the server racks that is separate from the networking pathways defined for the region. The Bastions can be services executing on the server devices of the scalable footprint data center that provide network access via the underlay network and do not have public network addresses. The Bastions can provide remote access to computing resources within the dedicated region 502 in conjunction with a Bastion service that operates on the underlay network. Similarly, network time protocol (NTP) services may operate in the underlay network to provide accurate timing to devices and services within the dedicated region 502. BIOS services can include services that are hosted on the one or more BIOS devices on the hyperconverged server racks of the scalable footprint data center. As one example, the BIOS services can include a key encryption service usable to encrypt/decrypt data on the server devices of scalable footprint data center during the initial boot process. As another example, the BIOS services can include a network configuration service that can provide the initial network configuration for devices within the scalable footprint data center. The VNIC(s) can include network interfaces defined by SmartNICs connected to the server devices within the dedicated region 502.

In addition to management provided via region management 558 via bastions, a CSP can provide management and monitoring of resources in the dedicated region 502 via out-of-band (OOB) management connection 560. The OOB management connection 560 can be a last resort recovery connection using a direct internet access server. The direct internet access server can be deployed off the main network of the dedicated region 502. For example, the OOB management connection 560 can be via a server connected to a specific port of one TOR of a hyperconverged server rack in the dedicated region 502. The OOB management connection 560 can have terminal service connection to the edge routers of the dedicated region 502. The CSP can use narrow access control lists (ACLs) and strong authentication protocols for connections over the OOB management connection 560, thereby limiting the sources of inbound connections to the dedicated region 502 over the OOB management connection 560. Because the OOB management connection 560 dedicated server is not in the edge network of the dedicated region 502, it can use network address space from an ISP and can remain a viable pathway to the dedicated region 502 even in situations when the internal networking configuration of the dedicated region 502 fails.

FIG. 6 is a block diagram illustrating an example architecture 600 for networking in a scalable footprint data center including dedicated region 502, according to some embodiments. The architecture 600 can be an example of the infrastructure 500 of FIG. 5. As described above with respect to FIG. 5, the dedicated region 502 can connect to additional regions 604 as well as customer on-premises infrastructure 606, which can be examples of dedicated region 504 and customer on-premises infrastructure 506, respectively.

Each VCN in the dedicated region 502 can include networking components that allow for connections between locations in the dedicated region 502. Using VCN 520 as an example, these networking components can include the DRG 528, an Internet gateway 610, a NAT gateway 612, and a service gateway 614.

In some examples, the Internet gateway 610 can provide direct connectivity to the public Internet 620 for resources in the VCN 520. The Internet gateway 610 can be instantiated for the VCN 520 by the customer operating the VCN 520. That is to say, not every VCN in the dedicated region 502 may have an Internet gateway 610 to provide networking connection to the Internet 620. Resources in the VCN 520 (e.g., VM 534) can be in a public subnet (e.g., public subnet 530) with public IP addresses. The route table 538 and security lists 536 can control the types of traffic allowed in and out of the resources to/from the Internet 620. The Internet gateway 610 can support connections initiated from within the VCN 520 (egress) and connections initiated from the Internet (ingress). Endpoints addressable with the Internet gateway 610 can include IP addresses of the CSP's public IP pool 616.

In some examples, the NAT gateway 612 can provide private subnet instances access to the Internet 620. These instances can initiate connections to the Internet and receive responses, but the NAT gateway 612 can be configured to not allow inbound connections initiated from the Internet 620. The NAT gateway 612 can be highly available and support TCP, UDP, and ICMP ping traffic.

In some examples, the service gateway 614 can provide connections for resources in the VCN 520 to CSP services. The CSP services can be in the dedicated region 502. The CSP service network can include endpoints for CSP services that have public IP addresses. The service gateway 614 can be configured to provide a private path to these CSP service endpoints.

In some examples, the DRG 528 can enable remote peering within and between regions (e.g., additional regions 604) and to customer on-premises infrastructure 606. Customers of the CSP can control the routes that are advertised using the DRG 528. In addition, identity and access management (IAM) policies can be implemented for peering between VCNs using a DRG. For example, VCN 520 can peer with another VCN in the dedicated region 502 using DRG 528 and a suitable IAM policy to authenticate the resources that connect between the VCNs.

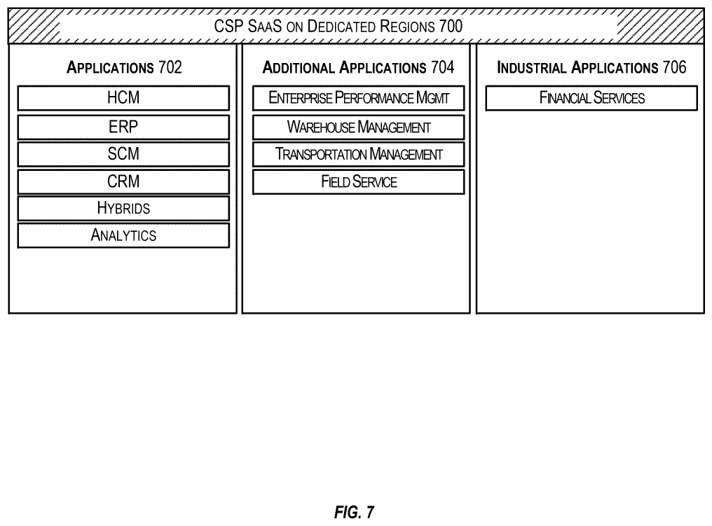

FIG. 7 is a block diagram illustrating example software-as-a-service (SaaS) applications 700 that can be provided from a scalable footprint data center, according to some embodiments. The scalable footprint data center providing the SaaS applications 700 can be an example of the scalable footprint data center 400 of FIG. 4, including any of the scalable region footprints described herein.

The SaaS applications 700 can include applications 702, additional applications 704, and industrial applications 706. The applications 702 can include human capital management solutions, enterprise resource planning, supply chain and manufacturing applications, customer relationship management, hybrid solutions, and analytics applications for analyzing data from one or more of the SaaS applications provided in the scalable footprint data center environment. The additional applications 704 can include enterprise performance management, warehouse management applications, transportation management solutions, and field service applications. Industrial applications 706 can include various financial services. The SaaS applications can be provided on customer-specific basis and can be hosted in corresponding customer tenancies in the overlay network of the scalable footprint data center.

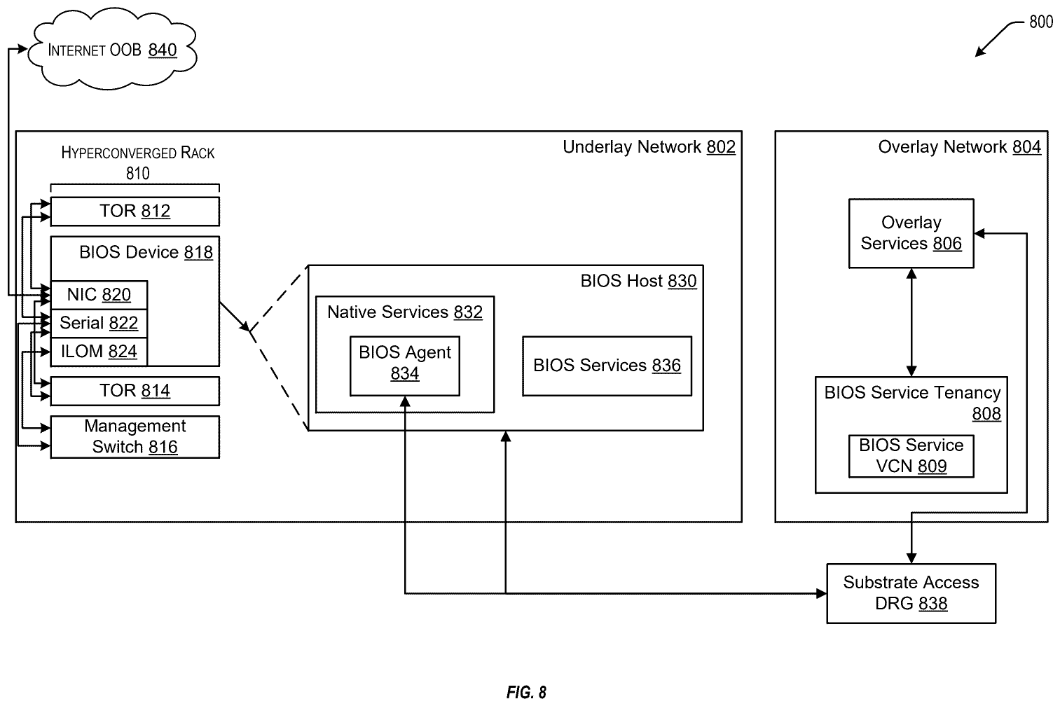

FIG. 8 is a block diagram illustrating a BIOS server architecture in a scalable footprint data center 800, according to some embodiments. The scalable footprint data center 800 can include an underlay network 802 and an overlay network 804. The services and other processes operating in the overlay network 804 can communicate with devices in the underlay network via a substrate access dynamic route gateway (DRG) 838, which can be an example of the DRG 528 described above with respect to FIG. 5 for a particular case of the VCN 520 that is a substrate access VCN. The substrate access VCN can be configured to provide networking routes between one or more other VCNs (e.g., customer VCNs) and the networking devices (e.g., SmartNICs) and other networking components of the substrate services that now execute in their own VCN in the overlay network.

The underlay network 802 can include a portion of multiple hyperconverged racks, including hyperconverged rack 810. The hyperconverged rack 810 may be an example of the hyperconverged rack 200 described above with respect to FIG. 2. The underlay network 802 can include the physical components of the hyperconverged rack that form the network of devices for managing the vestigial “substrate” services that are not moved into the overlay network (e.g., overlay network 804) in the scalable footprint region architecture. For example, the underlay network 802 can include the portion of hyperconverged rack 810 that has the switches (e.g., TOR 812, TOR 814, management switch 816) and bare metal server device configured as a BIOS device (e.g., BIOS device 818), while other components of hyperconverged rack 810 may be part of the overlay network 804 (not depicted in FIG. 8). For instance, the server devices of hyperconverged rack 810 that host Compute VMs for use by overlay service 806 or customer applications may be part of the overlay network 804.

Hyperconverged rack 810 can include TOR 812, TOR 814, management switch 816, and BIOS device 818. TOR 812 and TOR 814 may be examples of TOR 206 and TOR 208 of FIG. 2. TOR 812 and TOR 814 may be configured to provide switching functionality (e.g., Layer 2 and/or Layer 3 switching) for network traffic to/from the computing devices of hyperconverged rack 810 and to other computing devices in the scalable footprint data center 800. In some embodiments, TOR 812 can be connected to one or more of the server devices (e.g., server devices 204 of FIG. 2) of hyperconverged rack 810, while TOR 814 can be connected to one or more other server devices of hyperconverged rack 810. In some examples, TOR 812 and TOR 814 can be connected to each computing device of hyperconverged rack 810. TOR 812 and TOR 814 can also be connected to other networking devices of the scalable footprint data center 800, including TORs of additional hyperconverged racks. In this way, the computing devices of the racks in scalable footprint data center 800 can be connected together to allow routing of network traffic to/from the various computing devices. The management switch 816 can connect to ILOM interfaces at the computing devices of hyperconverged rack 810 to allow for network access to the computing devices in the event of a failure of networking devices in the scalable footprint data center 800, including TOR 812 or TOR 814.

BIOS device 818 can include a network interface controller (NIC) 820, a serial interface 822, and ILOM 824. The NIC 820 can provide a physical networking interface to the TOR 812, TOR 814, or the out of band Internet connection 840. The NIC 820 can include interfaces for various physical networking connections, including small form-factor pluggable (SFP), quad small form-factor pluggable (QSFP), modular connections, and the like. The NIC 820 can support network connections using various networking protocols, including Ethernet, FibreChannel, and the like. The NIC 820 can connect the BIOS device 818 to both TOR 812 and TOR 814, using separate interfaces. NIC 820 can also provide an interface to connected BIOS device 818 to a public network (e.g., the Internet) via an out-of-band (OOB) channel 840. The OOB connection can allow for access to the BIOS device 818 from the public network in the event of a loss of network connectivity to or within the scalable footprint data center 800. The OOB connection may have restrictions for which authorized systems may connect to the BIOS device 818 over the OOB channel. In some embodiments, only BIOS device 818 may have a network connection to the Internet OOB 840, so that BIOS devices of other hyperconverged racks in the scalable footprint data center do not have network connections to the Internet OOB 840. In other embodiments, additional BIOS devices can also include a network connection to the Internet OOB 840.

The serial interface 822 can provide a direct connection between the BIOS device 818 and the switches in hyperconverged rack 810, including TOR 812, TOR 814, and management switch 816. The serial interface 822 can provide the BIOS device 818 with command line access to the switches to allow for configuration of the switches in the event that the switches are not reachable via the typical networking protocol (e.g., the networking configuration within hyperconverged rack 810 is faulty).

As discussed briefly above, the scalable footprint data center 800 can include multiple BIOS devices. In some configurations, each rack in the scalable footprint data center 800 can include a single BIOS device. In other configurations, a single rack can include three BIOS devices. For redundancy in the event of a failure of a BIOS device, a scalable footprint data center can include a minimum of three BIOS devices, any one of which is sufficient to bootstrap the recovery of an entire region of the scalable footprint data center.

Each BIOS device in the scalable footprint data center 800 can host a bare metal instance of software applications, processes, and/or services to support the initial startup of the scalable footprint data center 800 or the recovery of the scalable footprint data center 800 from a shutdown or failure state. As depicted in FIG. 8, BIOS device 818 can include BIOS host 830, which may be an exemplary software architecture for a BIOS device in the scalable footprint data center 800. BIOS host 830 can be a bare metal instance executing on the BIOS device 818, including an operating system, native service 832, and BIOS services 836. The native service 832 can include BIOS agent 834 as well as a PKI agent and a deployment orchestrator agent for deploying and managing containers within the BIOS host 830 (e.g., an orchestrator for a container engine like Docker or Kubernetes). The native service 832 may be software configured as part of the software image for the BIOS device 818 and may execute automatically whenever the BIOS device 818 is powered on. The BIOS agent 834 may be configured to perform operations for starting the BIOS service 836 and receiving instructions from services in the overlay network 804 (e.g., overlay services 806) for controlling the BIOS services 836.

The BIOS services 836 can include the vestigial “Substrate” services that remain in the underlay network 802 without being implemented in the overlay network 804 in the scalable footprint data center 800. The BIOS services 836 can include a domain name system (DNS) service, a dynamic host configuration protocol (DHCP) service, a network time protocol (NTP) service, a border gateway protocol (BGP) service, a key exchange service (KES), a compute snapshot service, and a VCN snapshot service. The DNS, DHCP, NTP, and BGP services can be configured to provide networking functionality within the scalable footprint data center 800 of DNS, DHCP, NTP, and BGP services known in the art. The KES can be configured to perform fundamental key generation, key exchange, and related cryptographic operations to support the vending of decryption keys to computing devices within the scalable footprint data center 800 during initial startup or during recovery operations. For example, a KES of the BIOS services 836 on BIOS device 818 can be configured to vend keys to server devices within the hyperconverged rack 810 to decrypt local boot volumes at those server devices for use during the initial boot of bare metal instances and/or hypervisors and VMs executing on the server devices.

The overlay network 804 can include overlay services 806 and a tenancy for the BIOS service, BIOS service tenancy 808. As described above, the overlay services 806 can include the “core” Substrate services that are moved from bare metal instances in the underlay network 802 in a conventional data center environment to the overlay network 804 in a scalable footprint data center 800. The overlay services 806 can include Compute service control plane, a public key infrastructure (PKI) service, a Certificates service, an Identity service, a deployment orchestration service, and other services for deploying and configuring infrastructure components in the scalable footprint data center 800.

The BIOS service tenancy 808 may define a portion of the infrastructure resources of the overlay network 804 that is reserved for the BIOS service. For example, a BIOS control plane may be implemented in a BIOS service VCN 809, which can include one or more VMs executing within the overlay network 804 to host the processes of the BIOS control plane. The BIOS control plane can communicate with the BIOS services 806 via BIOS agent 834 to perform operations for maintaining the BIOS services 836 during steady state operation of the scalable footprint data center 800.

### Building a Butterfly Network Using a Prefab Factory

As described above, the components of a scalable footprint data center (e.g., a Butterfly region) can be initially configured in a prefab factory. The prefab factory can centralize the process of building a Butterfly region to provide more efficient use of computing and networking resources that support region build. For example, the prefab factory may be sited “close” (e.g., with low-latency and high data rate networking connections) to a host region that includes the prefab services and/or a ViBE. One or more prefab services, including, for example, an orchestration service, reconfiguration service, and replicator service, can be hosted by a CSP that can manage bootstrapping (e.g., provisioning and deploying software to) infrastructure components for one or more Butterfly regions within the prefab factory. The orchestration service can then orchestrate the provisioning of the Butterfly region infrastructure and deployment of software resources to the Butterfly infrastructure.

The prefab factory can be a facility similar to a data center, including sufficient power, cooling, and networking infrastructure to support building one or more regions. The prefab factory may be located in proximity to existing computing infrastructure of a CSP. A Butterfly region being built in the prefab factory can include the hyperconverged racks for initial footprint, including, for example, three hyperconverged racks, four hyperconverged racks, six hyperconverged racks, or even as few as a single hyperconverged rack. The prefab factory may be connected over one or more networks to services provided by a CSP. During region build operations, the CSP supporting prefab operations can provision infrastructure components on the physical resources of the Butterfly region and deploy software resources, configurations, and/or other artifacts to the provisioned infrastructure components. The prefab region may be brought to a state that is close to the final production state of the devices when they are installed at the destination facility. The Butterfly region can then be configured for transportation to the destination site and then delivered and installed at the destination site. For example, a customer facility can receive a Butterfly region configured in a prefab factory for use as a scalable footprint data center in the customer facility.

For Butterfly regions built in a prefab factory, the prefab services can perform operations to deploy the software resources to the physical components (e.g., server devices 204 of FIG. 2) using device images. For example, a template Butterfly region can be built with individual infrastructure and software components deployed in an orchestrated manner. Once built, each device of the template Butterfly region can be imaged to create an image set that corresponds to the network topology and hardware configuration of the template Butterfly region. Image sets can therefore be generated for different “shapes” of Butterfly regions, for instance the three-, six-, or 12-rack configurations. In some cases the building of the template Butterfly region can occur in a production region (e.g., the host region). For example, the host region can be connected to racks for the template Butterfly region, build a ViBE, deploy the software to the racks, perform pre-imaging configurations, image the racks, and store the image set on a suitable storage device. In some cases, building the template Butterfly region can occur in the prefab factory connected to the host region.

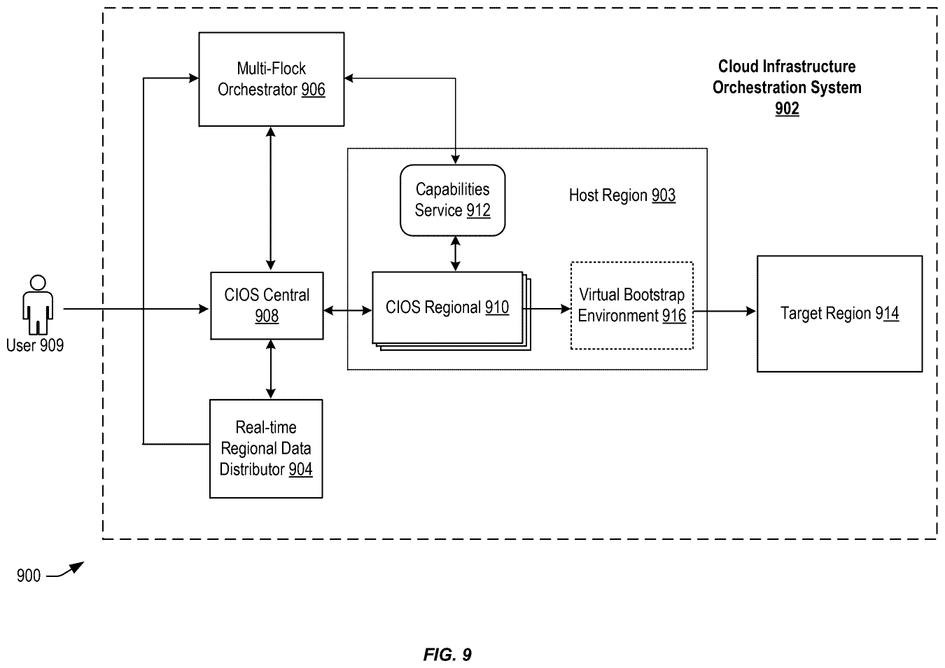

Building the template BF region can include deploying resources to the infrastructure components of the template BF region using a ViBE. FIGS. 9-11, below, provide a description of the orchestrated provisioning and deployment of resources in a region, including a region of a scalable footprint data center.

Since services in the region for the scalable footprint data center will run in the overlay, modifications to a typical ViBE deployment can be made to improve the speed at which the ViBE itself is built. In particular, the ViBE can be configured so that certain services deployed to the ViBE can be deployed “out of order” from a typical dependency order. In addition, the ViBE can be configured to proxy traffic for services that have scaled out into the target region (e.g., the template Butterfly region) to the services still in the ViBE and for services in the ViBE and services in the host region.

Numerous advantages can be realized by building a scalable footprint data center (e.g., Butterfly region) in a prefab factory using a ViBE. In addition to the advantages provided by the Butterfly configuration itself, in which core services operate in the Overlay network, the prefab factory allows for rapid configuration of multiple Butterfly regions. Certain services deployed to the ViBE can be deployed prior to or simultaneously with services on which they depend. Services having a dependency on another service not yet deployed to the ViBE can rely on the instance of the service in the host region until the dependency service has fully deployed to the ViBE. In doing so, the ViBE can be built much faster than would be possible if each service deployment waited until all dependencies were deployed.

### Example ViBE Implementation

In some examples, techniques for a Cloud Infrastructure Orchestration Service (CIOS) can be used to implement in a ViBE in a host region. Such techniques, as described briefly above, can be configured to manage bootstrapping (e.g., provisioning and deploying software to) infrastructure components within a cloud environment (e.g., a region). In some instances, the CIOS can include computing components (e.g., a CIOS Central and a CIOS Regional, both of which will be described in further detail below) that may be configured to manage bootstrapping tasks (provisioning and deployment) for a given service and a Multi-Flock Orchestrator (also described in further detail below) configured to initiate/manage region builds (e.g., bootstrapping operations corresponding to multiple services).

The CIOS enables region building and world-wide infrastructure provisioning and code deployment with minimal manual run-time effort from service teams (e.g., beyond an initial approval and/or physical transportation of hardware, in some instances). The high-level responsibilities of the CIOS include, but are not limited to, coordinating region builds, providing users with a view of the current state of resources managed by the CIOS (e.g., of a region, across regions, world-wide, etc.), and managing bootstrapping operations for bootstrapping resources within a region.

The CIOS may provide view reconciliation, where a view of a desired state (e.g., a desired configuration) of resources may be reconciled with a current/actual state (e.g., a current configuration) of the resources. In some instances, view reconciliation may include obtaining state data to identify what resources are actually running and their current configuration and/or state. Reconciliation can be performed at a variety of granularities, such as at a service level.

The CIOS can perform plan generation, where differences between the desired and current state of the resources are identified. Part of plan generation can include identifying the operations that would need to be executed to bring the resources from the current state to the desired state. In some examples, the CIOS may present a generated plan to a user for approval. In these examples, the CIOS can mark the plan as approved or rejected based on user input from the user. Thus, users can spend less time reasoning about the plan and the plans are more accurate because they are machine generated. Plans are almost too detailed for human consumption; however, the CIOS can provide this data via a sophisticated user interface (UI).

The CIOS can measure service health by monitoring alarms and executing integration tests. The CIOS can help teams quickly define roll-back behavior in the event of service degradation, which it can later execute. The CIOS can generate and display plans and can track approval. The CIOS can combine the functionality of provisioning and deployment in a single system that coordinates these tasks across a region build. The CIOS also supports the discovery of flocks (e.g., service resources such as flock config(s) corresponding to any suitable number of services), artifacts, resources, and dependencies. The CIOS can discover dependencies between execution tasks at every level (e.g., resource level, execution target level, phase level, service level, etc.) through a static analysis (e.g., including parsing and processing content) of one or more configuration files. Using these dependencies, the CIOS can generate various data structures from these dependencies that can be used to drive task execution (e.g., tasks regarding provisioning of infrastructure resources and deployment of artifacts across the region).

FIG. 9 is a block diagram of an environment 900 in which a Cloud Infrastructure Orchestration Service (CIOS) 902 may operate to dynamically provide bootstrap services in a region, according to at least one embodiment. CIOS 902 can include, but is not limited to, the following components: Real-time Regional Data Distributor (RRDD) 904, Multi-Flock Orchestrator (MFO) 906, CIOS Central 908, CIOS Regional 910, and Capabilities Service 912. Specific functionality of CIOS Central 908 and CIOS Regional 910 is provided in more detail in U.S. application Ser. No. 97/016,754, entitled “Techniques for Deploying Infrastructure Resources with a Declarative Provisioning Tool,” the entire contents of which are incorporated in its entirety for all purposes. In some embodiments, any suitable combination of the components of CIOS 902 may be provided as a service. In some embodiments, some portion of CIOS 902 may be deployed to a region (e.g., a data center represented by host region 903). In some embodiments, CIOS 902 may include any suitable number of cloud services (not depicted in FIG. 9) discussed in further detail in U.S. application Ser. No. 97/016,754 and below with respect to FIGS. 2 and 3.

Real-time Regional Data Distributor (RRDD) 904 may be configured to maintain and provide region data that identifies realms, regions, execution targets, and availability domains. In some cases, the region data may be in any suitable form (e.g., JSON format, data objects/containers, XML, etc.). Region data maintained by RRDD 904 may include any suitable number of subsets of data which can individually be referenceable by a corresponding identifier. By way of example, an identifier “all_regions” can be associated with a data structure (e.g., a list, a structure, an object, etc.) that includes a metadata for all defined regions. As another example, an identifier such as “realms” can be associated with a data structure that identifies metadata for a number of realms and a set of regions corresponding to each realm. In general, the region data may maintain any suitable attribute of one or more realm(s), region(s), availability domains (ADs), execution target(s) (ETs), and the like, such as identifiers, DNS suffixes, states (e.g., a state of a region), and the like. The RRDD 904 may be configured to manage region state as part of the region data. A region state may include any suitable information indicating a state of bootstrapping within a region. By way of example, some example region states can include “initial,” “building,” “production,” “paused,” or “deprecated.” The “initial” state may indicate a region that has not yet been bootstrapped. A “building” state may indicate that bootstrapping of one or more flocks within the region has commenced. A “production” state may indicate that bootstrapping has been completed and the region is ready for validation. A “paused” state may indicate that CIOS Central 908 or CIOS Regional 910 has paused internal interactions with the regional stack, likely due to an operational issue. A “deprecated” state may indicate the region has been deprecated and is likely unavailable and/or will not be contacted again.

CIOS Central 908 is configured to provide any suitable number of user interfaces with which users (e.g., user 909) may interact with CIOS 902. By way of example, users can make changes to region data via a user interface provided by CIOS Central 908. CIOS Central 908 may additionally provide a variety of interfaces that enable users to: view changes made to flock configs and/or artifacts, generate and view plans, approve/reject plans, view status on plan execution (e.g., corresponding to tasks involving infrastructure provisioning, deployment, region build, and/or desired state of any suitable number of resources managed by CIOS 902. CIOS Central 908 may implement a control plane configured to manage any suitable number of CIOS Regional 910 instances. CIOS Central 908 can provide one or more user interfaces for presenting region data, enabling the user 909 to view and/or change region data. CIOS Central 908 can be configured to invoke the functionality of RRDD 904 via any suitable number of interfaces. Generally, CIOS Central 908 may be configured to manage region data, either directly or indirectly (e.g., via RRDD 904). CIOS Central 908 may be configured to compile flock configs to inject region data as variables within the flock configs.

Each instance of CIOS Regional 910 may correspond to a component or module configured to execute bootstrapping tasks that are associated with a single service of a region. CIOS Regional 910 can receive desired state data from CIOS Central 908. In some embodiments, desired state data may include a flock config that declares (e.g., via declarative statements) a desired state of resources associated with a service. CIOS Central 908 can maintain current state data indicating any suitable aspect of the current state of the resources associated with a service. In some embodiments, CIOS Regional 910 can identify, through a comparison of the desired state data and the current state data, that changes are needed to one or more resources. For example, CIOS Regional 910 can determine that one or more infrastructure components need to be provisioned, one or more artifacts deployed, or any suitable change needed to the resources of the service to bring the state of those resources in line with the desired state. As CIOS Regional 910 performs bootstrapping operations, it may publish data indicating various capabilities of a resource as they become available. A “capability” identifies a unit of functionality associated with a service. The unit could be a portion, or all of the functionality to be provided by the service. By way of example, a capability can be published indicating that a resource is available for authorization/authentication processing (e.g., a subset of the functionality to be provided by the resource). As another example, a capability can be published indicating the full functionality of the service is available. Capabilities can be used to identify functionality on which a resource or service depends and/or functionality of a resource or service that is available for use.

Capabilities Service 912 is configured to maintain capabilities data that indicates 9) what capabilities of various services are currently available, 2) whether any resource/service is waiting on a particular capability, 3) what particular resources and/or services are waiting on a given capability, or any suitable combination of the above. Capabilities Service 912 may provide an interface with which capabilities data may be requested. Capabilities Service 912 may provide one or more interfaces (e.g., application programming interfaces) that enable it to transmit capabilities data to MFO 906 and/or CIOS Regional 910 (e.g., each instance of CIOS Regional 910). In some embodiments, MFO 906 and/or any suitable component or module of CIOS Regional 910 may be configured to request capabilities data from Capabilities Service 912.

In some embodiments, Multi-Flock Orchestrator (MFO) 906 may be configured to drive region build efforts. In some embodiments, MFO 906 can manage information that describes what flock/flock config versions and/or artifact versions are to be utilized to bootstrap a given service within a region (or to make a unit of change to a target region). In some embodiments, MFO 906 may be configured to monitor (or be otherwise notified of) changes to the region data managed by Real-time Regional Data Distributor 904. In some embodiments, receiving an indication that region data has been changed may cause a region build to be triggered by MFO 906. In some embodiments, MFO 906 may collect various flock configs and artifacts to be used for a region build. Some, or all, of the flock configs may be configured to be region agnostic. That is, the flock configs may not explicitly identify what regions to which the flock is to be bootstrapped. In some embodiments, MFO 906 may trigger a data injection process through which the collected flock configs are recompiled (e.g., by CIOS Central 908). During recompilation, operations may be executed (e.g., by CIOS Central 908) to cause the region data maintained by Real-time Regional Data Distributor 904 to be injected into the config files. Flock configs can reference region data through variables/parameters without requiring hard-coded identification of region data. The flock configs can be dynamically modified at run time using this data injection rather than having the region data be hardcoded, and therefore, and more difficult to change.

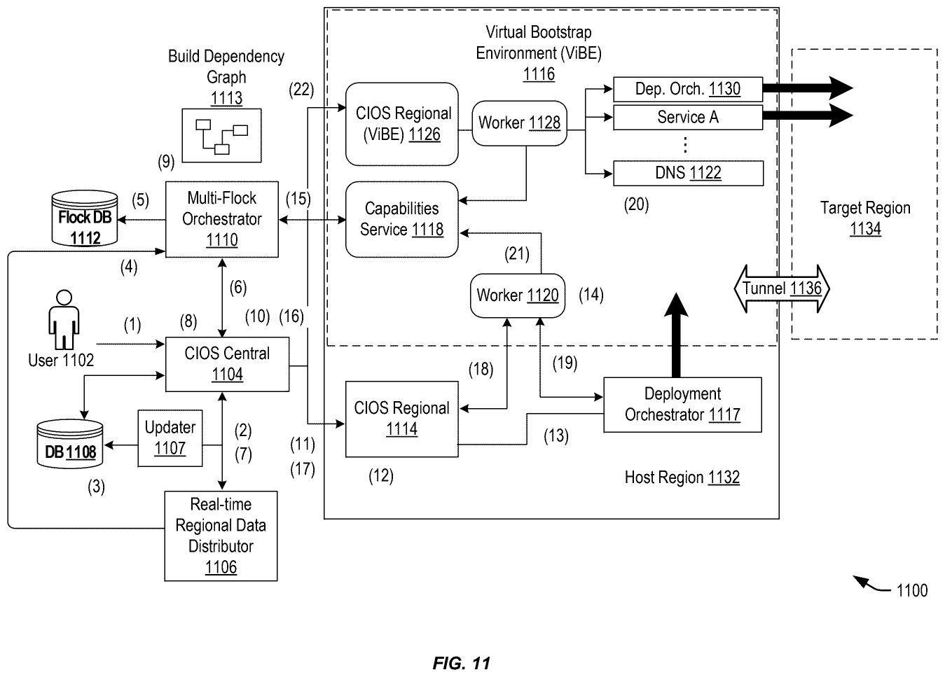

Multi-Flock Orchestrator 906 can perform a static flock analysis in which the flock configs are parsed to identify dependencies between resources, execution targets, phases, and flocks, and in particular to identify circular dependencies that need to be removed. In some embodiments, MFO 906 can generate any suitable number of data structures based on the dependencies identified. These data structures (e.g., directed acyclic graph(s), linked lists, etc.) may be utilized by the Cloud Infrastructure Orchestration Service 902 to drive operations for performing a region build. By way of example, these data structures may collectively define an order by which services are bootstrapped within a region. An example of such a data structure is discussed further below with respect to Build Dependency Graph 1113 of FIG. 11. If circular dependencies (e.g., service A requires service B and vice versa) exist and are identified through the static flock analysis and/or graph, MFO may be configured to notify any suitable service teams that changes are required to the corresponding flock config to correct these circular dependencies. MFO 906 can be configured to traverse one or more data structures to manage an order by which services are bootstrapped to a region. MFO 906 can identify (e.g., using data obtained from Capabilities Service 912) capabilities available within a given region at any given time. MFO 906 can this data to identify when it can bootstrap a service, when bootstrapping is blocked, and/or when bootstrapping operations associated with a previously blocked service can resume. Based on this traversal, MFO 906 can perform a variety of releases in which instructions are transmitted by MFO 906 to CIOS Central 908 to perform bootstrapping operations corresponding to any suitable number of flock configs. In some examples, MFO 906 may be configured to identify that one or more flock configs may require multiple releases due to circular dependencies found within the graph. As a result, MFO 906 may transmit multiple instruction sets to CIOS Central 908 for a given flock config to break the circular dependencies identified in the graph.

In some embodiments, a user can request that a new region (e.g., target region 914) be built. This can involve bootstrapping resources corresponding to a variety of services. In some embodiments, target region 914 may not be communicatively available (and/or secure) at a time at which the region build request is initiated. Rather than delay bootstrapping until such time as target region 914 is available and configured to perform bootstrapping operations, CIOS 902 may initiate the region build using a virtual bootstrap environment 916. Virtual bootstrap environment (ViBE) 916 may be an overlay network that is hosted by host region 903 (a preexisting region that has previously been configured with a core set of services and which is communicatively available and secure). MFO 906 can leverage resources of the host region 903 to bootstrap resources to the ViBE 916 (generally referred to as “building the ViBE”). By way of example, MFO 906 can provide instructions through CIOS Central 908 that cause an instance of CIOS Regional 910 within a host region (e.g., host region 903) to bootstrap another instance of CIOS Regional within the ViBE 916. Once the CIOS Regional within the ViBE is available for processing, bootstrapping the services for the target region 914 can continue within the ViBE 916. When target region 914 is available to perform bootstrapping operations, the previously bootstrapped services within ViBE 916 may be migrated to target region 914. Utilizing these techniques, CIOS 902 can greatly improve the speed at which a region is built by drastically reducing the need for any manual input and/or configuration to be provided.

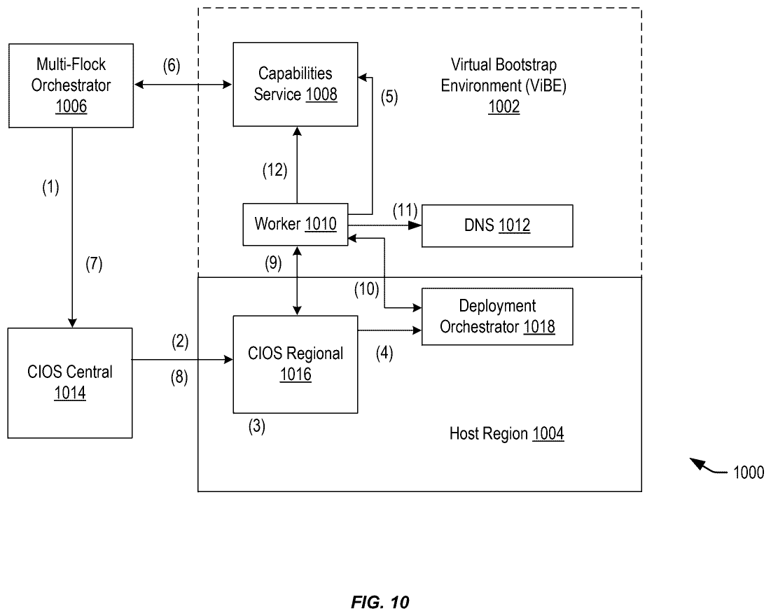

FIG. 10 is a block diagram for illustrating an environment 1000 and method for building a virtual bootstrap environment (ViBE) 1002 (an example of ViBE 916 of FIG. 9), according to at least one embodiment. ViBE 1002 represents a virtual cloud network that is provisioned in the overlay of an existing region (e.g., host region 1004, an example of the host region 903 of FIG. 9 and in an embodiment is a Host Region Service Enclave). ViBE 1002 represents an environment in which services can be staged for a target region (e.g., a region under build such as target region 914 of FIG. 9) before the target region becomes available.

In order to bootstrap a new region (e.g., target region 914 of FIG. 9), a core set of services may be bootstrapped. While those core set of services exist in the host region 1004, they do not yet exist in the ViBE (nor the target region). These essential core services provide the functionality needed to provision devices, establish a chain of trust to the new region, and deploy remaining services (e.g., flocks) into a region. The ViBE 1002 may be a tenancy that is deployed in a host region 1004. It can be thought of as a virtual region.

When the target region is available to provide bootstrapping operations, the ViBE 1002 can be connected to the target region so that services in the ViBE can interact with the services and/or infrastructure components of the target region. This will enable deployment of production level services, instead of self-contained seed services as in previous systems, and will require connectivity over the internet to the target region. Conventionally, a seed service was deployed as part of a container collection and used to bootstrap dependencies necessary to build out the region. Using infrastructure/tooling of an existing region, resources may be bootstrapped (e.g., provisioned and deployed) into the ViBE 1002 and connected to the service enclave of a region (e.g., host region 1004) in order to provision hardware and deploy services until the target region is self-sufficient and can be communicated with directly. Utilizing the ViBE 1002 allows for standing up the dependencies and services needed to be able to provision/prepare infrastructure and deploy software while making use of the host region's resources in order to break circular dependencies of core services.

Multi-Flock Orchestrator (MFO) 1006 may be configured to perform operations to build (e.g., configure) ViBE 1002. MFO 1006 can obtain applicable flock configs corresponding to various resources to be bootstrapped to the new region (in this case, a ViBE region, ViBE 1002). By way of example, MFO 1006 may obtain a flock config (e.g., a “ViBE flock config”) that identifies aspects of bootstrapping Capabilities Service 1008 and Worker 1010. As another example, MFO 1006 may obtain another flock config corresponding to bootstrapping Domain Name Service (DNS) 1012 to ViBE 1002.

At step 1, MFO 1006 may instruct CIOS Central 1014 (e.g., an example of CIOS Central 908 and CIOS Central 1014 of FIGS. 9 and 10, respectively). For example, MFO 1006 may transmit a request (e.g., including the ViBE flock config) to request bootstrapping of the Capabilities Service 1008 and Worker 1010 that, at this time do not yet exist in the VIBE 1002. In some embodiments, CIOS Central 1014 may have access to all flock configs. Therefore, in some examples, MFO 1006 may transmit an identifier for the ViBE flock config rather than the file itself, and CIOS Central 1014 may independently obtain it from storage.

At step 2, CIOS Central 1014 may provide the ViBE flock config via a corresponding request to CIOS Regional 1016. CIOS Regional 1016 may parse the ViBE flock config to identify and execute specific infrastructure provisioning and deployment operations at step 3.

In some embodiments, the CIOS Regional 1016 may utilize additional corresponding services for provisioning and deployment. For example, at step 4, CIOS Regional 1016 CIOS Regional may instruct deployment orchestrator 1018 (e.g., an example of a core service, or other write, build, and deploy applications software, of the host region 1004) to execute instructions that in turn cause Capabilities Service 1008 and Worker 1010 to be bootstrapped within ViBE 1002.

At step 5, a capability may be transmitted to the Capabilities Service 1008 (from the CIOS Regional 1016, Deployment Orchestrator 1018 via the Worker 1010 or otherwise) indicating that resources corresponding to the ViBE flock are available. Capabilities Service 1008 may persist this data. In some embodiments, the Capabilities Service 1008 adds this information to a list it maintains of available capabilities with the ViBE. By way of example, the capability provided to Capabilities Service 1008 at step 5 may indicate the Capabilities Service 1008 and Worker 1010 are available for processing.

At step 6, MFO 1006 may identify that the capability indicating that Capabilities Service 1008 and Worker 1010 are available based on receiving or obtaining data (an identifier corresponding to the capability) from the Capabilities Service 1008.

At step 7, as a result of receiving/obtaining the data at step 6, the MFO 1006 may instruct CIOS Central 1014 to bootstrap a DNS service (e.g., DNS 1012) to the ViBE 1002. The instructions may identify or include a particular flock config corresponding to the DNS service.

At step 8, the CIOS Central 1014 may instruct the CIOS Regional 1016 to deploy DNS 1012 to the ViBE 1002. In some embodiments, the DNS flock config for the DNS 1012 is provided by the CIOS Central 1014.

At step 9, Worker 1010, now that it is deployed in the ViBE 1002, may be assigned by CIOS Regional 1016 to the task of deploying DNS 1012. Worker may execute a declarative infrastructure provisioner in the manner described above in connection with FIG. 3 to identify (e.g., from comparing the flock config (the desired state) to a current state of the (currently non-existing) resources associated with the flock) a set of operations that need to be executed to deploy DNS 1012.

At step 10, the Deployment Orchestrator 1018 may instruct Worker 1010 to deploy DNS 1012 in accordance with the operations identified at step 9. As depicted, Worker 1010 proceeds with executing operations to deploy DNS 1012 to ViBE 1002 at step 11. At step 12, Worker 1010 notifies Capabilities Service 1008 that DNS 1012 is available in ViBE 1002. MFO 1006 may subsequently identify that the resources associated with the ViBE flock config and the DNS flock config are available any may proceed to bootstrap any suitable number of additional resources to the ViBE.

After steps 1-12 are concluded, the process for building the ViBE 1002 can be considered complete and the ViBE 1002 can be considered built.

FIG. 11 is a block diagram for illustrating an environment 1100 and method for bootstrapping services to a target region utilizing the ViBE, according to at least one embodiment.

At step 1, user 1102 may utilize any suitable user interface provided by CIOS Central 1104 to modify region data. By way of example, user 1102 may create a new region to which a number of services are to be bootstrapped.

At step 2, CIOS Central 1104 may execute operations to send the change to RRDD 1106. At step 3, RRDD 1106 may store the received region data in database 1108, a data store configured to store region data including any suitable identifier, attribute, state, etc. of a region, AD, realm, ET, or the like. In some embodiments, updater 1107 may be utilized to store region data in database 1108 or any suitable data store from which such updates may be accessible (e.g., to service teams). In some embodiments, updater 1107 may be configured to notify (e.g., via any suitable electronic notification) of updates made to database 1108.

At step 4, MFO 1110 may detect the change in region data. In some embodiments, MFO 1110 may be configured to poll RRDD 1106 for changes in region data. In some embodiments, RRDD 1106 may be configured to publish or otherwise notify MFO 1110 of region changes.

At step 5, detecting the change in region data may trigger MFO 1110 to obtain a version set (e.g., a version set associated with a particular identifier such as a “golden version set” identifier). identifying a particular version for each flock (e.g., service) that is to be bootstrapped to the new region and a particular version for each artifact corresponding to that flock. The version set may be obtained from DB 1112. As flocks evolve and change, the versions for their corresponding configs and artifacts used for region build may change. These changes may be persisted in flock DB 1112 such that MFO 1110 may identify which versions of flock configs and artifacts to use for building a region (e.g., a ViBE region, a Target Region/non-ViBE Region, etc.). The flock configs (e.g., all versions of the flock configs) and/or artifacts (e.g., all versions of the artifacts) may be stored in DB 1108, DB 1112, or any suitable data store accessible to the CIOS Central 1104 and/or MFO 1110.

At step 6, MFO 1110 may request CIOS Central 1104 to recompile of each of the flock configs associated with the version set with the current region data. In some embodiments, the request may indicate a version for each flock config and/or artifact corresponding to those flock configs.

At step 7, CIOS Central 1104 may obtain current region data from the DB 1108 (e.g., directly, or via Real-time Regional Data Distributor 1106) and retrieve any suitable flock config and artifact in accordance with the versions requested by MFO 1110.

At step 8, CIOS Central 1104 may recompile the flock configs with the region data obtained at step 7 to inject the flock configs with current region data. CIOS Central 1104 may return the compiled flock configs to MFO 1110. In some embodiments, CIOS Central 1104 may simply indicate compilation is done, and MFO 1110 may access the recompiled flock configs via RRDD 1106.

At step 9, MFO 1110 may perform a static analysis of the recompiled flock configs. As part of the static analysis, MFO 1110 may parse the flock configs (e.g., using a library associated with a declarative infrastructure provisioner (e.g., Terraform, or the like)) to identify dependencies between flocks. From the analysis and the dependencies identified, MFO 1110 can generate Build Dependency Graph 1138. Build Dependency Graph 1138 may be an acyclic directed graph that identifies an order by which flocks are to be bootstrapped (and/or changes indicated in flock configs are to be applied) to the new region. Each node in the graph may correspond to bootstrapping any suitable portion of a particular flock. The specific bootstrapping order may be identified based at least in part on the dependencies. In some embodiments, the dependencies may be expressed as an attribute of the node and/or indicated via edges of the graph that connect the nodes. MFO 1110 may traverse the graph (e.g., beginning at a starting node) to drive the operations of the region build.

In some embodiments, MFO 1110 may utilize a cycle detection algorithm to detect the presence of a cycle (e.g., service A depends on service B and vice versa). MFO 1110 can identify orphaned capabilities dependencies. For example, MFO 1110 can identify orphaned nodes of the Build Dependency Graph 1138 that do not connect to any other nodes. MFO 1110 may identify falsely published capabilities (e.g., when a capability was prematurely published, and the corresponding functionality is not actually yet available). MFO 1110 can detect from the graph that one or more instances of publishing the same capability exist. In some embodiments, any suitable number of these errors may be detected and MFO 1110 (or another suitable component such as CIOS Central 1104) may be configured to notify or otherwise present this information to users (e.g., via an electronic notification, a user interface, or the like). In some embodiments, MFO 1110 may be configured to force delete/recreate resources to break circular dependencies and may once again provide instructions to CIOS Central 1104 to perform bootstrapping operations for those resources and/or corresponding flock configs.

A starting node may correspond to bootstrapping the ViBE flock, a second node may correspond to bootstrapping DNS. The steps 10-15 correspond to deploying (via deployment orchestrator 1117 a ViBE flock to ViBE 1116. That is, steps 10-15 of FIG. 11 generally correspond to steps 1-6 of FIG. 10. Once notified that capabilities exist corresponding to the ViBE flock being deployed (e.g., indicating that Capabilities Service 1118 and Worker 1120, corresponding to Capabilities Service 1008 and Worker 1010 of FIG. 10, are available) the MFO 1110 recommence traversal of the Build Dependency Graph 1138 to identify next operations to be executed.

By way of example, MFO 1110 may continue traversing the Build Dependency Graph 1138 to identify that a DNS flock is to be deployed. Steps 16-21 may be executed to deploy DNS 1122 (an example of the DNS 1012 of FIG. 10). These operations may generally correspond to steps 7-12 of FIG. 10.

At step 21, a capability may be stored indicating that DNS 1122 is available. Upon detecting this capability, MFO 1110 may recommence traversal of the Build Dependency Graph 1138. On this traversal, the MFO 1110 may identify that any suitable portion of an instance of CIOS Regional (e.g., an example of CIOS Regional 1114) is to be deployed to the VIBE 1116. In some embodiments, steps 16-21 may be substantially repeated with respect to deploying CIOS Regional (ViBE) 1126 (an instance of CIOS Regional 1114, CIOS Regional 110 of FIG. 1) and Worker 1128 to the ViBE 1116. A capability may be transmitted to the Capabilities Service 1118 that CIOS Regional (ViBE) 1126 is available.

Upon detecting the CIOS Regional (ViBE) 1126 is available, MFO 1110 may recommence traversal of the Build Dependency Graph 1138. On this traversal, the MFO 1110 may identify that a deployment orchestrator (e.g., Deployment Orchestrator 1130, an example of the Deployment Orchestrator 1117) is to be deployed to the ViBE 1116. In some embodiments, steps 16-21 may be substantially repeated with respect to deploying Deployment Orchestrator 1130. Information that identifies a capability may be transmitted to the Capabilities Service 1118, indicating that Deployment Orchestrator 1130 is available.

After Deployment Orchestrator 1130 is deployed, ViBE 1116 may be considered available for processing subsequent requests. Upon detecting Deployment Orchestrator 1130 is available, MFO 1110 may instruct subsequent bootstrapping requests to be routed to ViBE components rather than utilizing host region components (components of host region 1132). Thus, MFO 1110 can continue traversing the Build Dependency Graph 1138, at each node instructing flock deployment to the ViBE 1116 via CIOS Central 1104. CIOS Central 1104 may request CIOS Regional (ViBE) 1126 to deploy resources according to the flock config.

At some point during this process, Target Region 1134 may become available. Indication that the Target Region is available may be identifiable from region data for the Target Region 1134 being provided by the user 1102 (e.g., as an update to the region data). The availability of Target Region 1134 may depend on establishing a network connection between the Target Region 1134 and external networks (e.g., the Internet). The network connection may be supported over a public network (e.g., the Internet), but use software security tools (e.g., IPSec) to provide one or more encrypted tunnels (e.g., IPSec tunnels such as tunnel 1136) from the ViBE 1116 to Target Region 1134. As used herein, “IPSec” refers to a protocol suite for authenticating and encrypting network traffic over a network that uses Internet Protocol (IP), and can include one or more available implementations of the protocol suite (e.g., Openswan, Libreswan, strongSwan, etc.). The network may connect the ViBE 1116 to the service enclave of the Target Region 1134.

Prior to establishing the IPSec tunnels, the initial network connection to the Target Region 1134 may be on a connection (e.g., an out-of-band VPN tunnel) sufficient to allow bootstrapping of networking services until an IPSec gateway may be deployed on an asset (e.g., bare-metal asset) in the Target Region 1134. To bootstrap the Target Region's 1134 network resources, Deployment Orchestrator 1130 can deploy the IPSec gateway at the asset within Target Region 1134. The Deployment Orchestrator 1130 may then deploy VPN hosts at the Target Region 1134 configured to terminate IPSec tunnels from the ViBE 1116. Once services (e.g., Deployment Orchestrator 1130, Service A, etc.) in the ViBE 1116 can establish an IPSec connection with the VPN hosts in the Target Region 1134, bootstrapping operations from the ViBE 1116 to the Target Region 1134 may begin.

In some embodiments, the bootstrapping operations may begin with services in the ViBE 1116 provisioning resources in the Target Region 1134 to support hosting instances of core services as they are deployed from the ViBE 1116. For example, a host provisioning service may provision hypervisors on infrastructure (e.g., bare-metal hosts) in the Target Region 1134 to allocate computing resources for VMs. When the host provisioning service completes allocation of physical resources in the Target Region 1134, the host provisioning service may publish information indicating a capability that indicates that the physical resources in the Target Region 1134 have been allocated. The capability may be published to Capabilities Service 1118 via CIOS Regional (ViBE) 1126 (e.g., by Worker 1128).

With the hardware allocation of the Target Region 1134 established and posted to capabilities service 1118, CIOS Regional (ViBE) 1126 can orchestrate the deployment of instances of core services from the VIBE 1116 to the Target Region 1134. This deployment may be similar to the processes described above for building the ViBE 1116, but using components of the ViBE (e.g., CIOS Regional (ViBE) 1126, Worker 1128, Deployment Orchestrator 1130) instead of components of the Host Region 1132 service enclave. The deployment operations may generally correspond to steps 16-21 described above.

As a service is deployed from the ViBE 1116 to the Target Region 1134, the DNS record associated with that service may correspond to the instance of the service in the ViBE 1116. The DNS record associated with the service may be updated at a later time to complete deployment of the service to the Target Region 1134. Said another way, the instance of the service in the ViBE 1116 may continue to receive traffic (e.g., requests) to the service until the DNS record is updated. A service may deploy partially into the Target Region 1134 and publish information indicating a capability (e.g., to Capabilities Service 1118) that the service is partially deployed. For example, a service running in the ViBE 1116 may be deployed into the Target Region 1134 with a corresponding compute instance, load balancer, and associated applications and other software, but may need to wait for database data to migrate to the Target Region 1134 before being completely deployed. The DNS record (e.g., managed by DNS 1122) may still be associated with the service in the ViBE 1116. Once data migration for the service is complete, the DNS record may be updated to point to the operational service deployed in the Target Region 1134. The deployed service in the Target Region 1134 may then receive traffic (e.g., requests) for the service, while the instance of the service in the ViBE 1116 may no longer receive traffic for the service.

### ViBE Deployment for Core Services in the Overlay

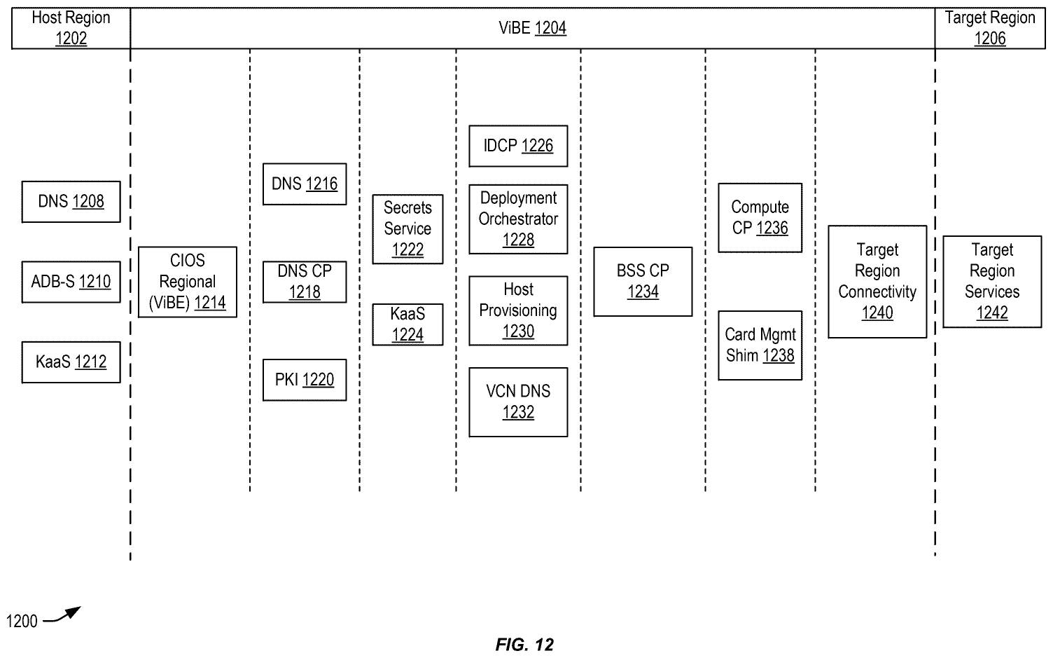

As discussed above, one aspect of a scalable footprint data center environment is an architectural change in which “core” services are hosted in an overlay network of the region. For a ViBE in a host region (e.g., host region 1203 of FIG. 12), the host region itself may implement the architectural change, so that services of the host region used to build the ViBE may now be in the overlay. For example, a domain name system (DNS) service in the host region may now be in the overlay, whereas in a conventional architecture the DNS service may have been hosted in the substrate network.

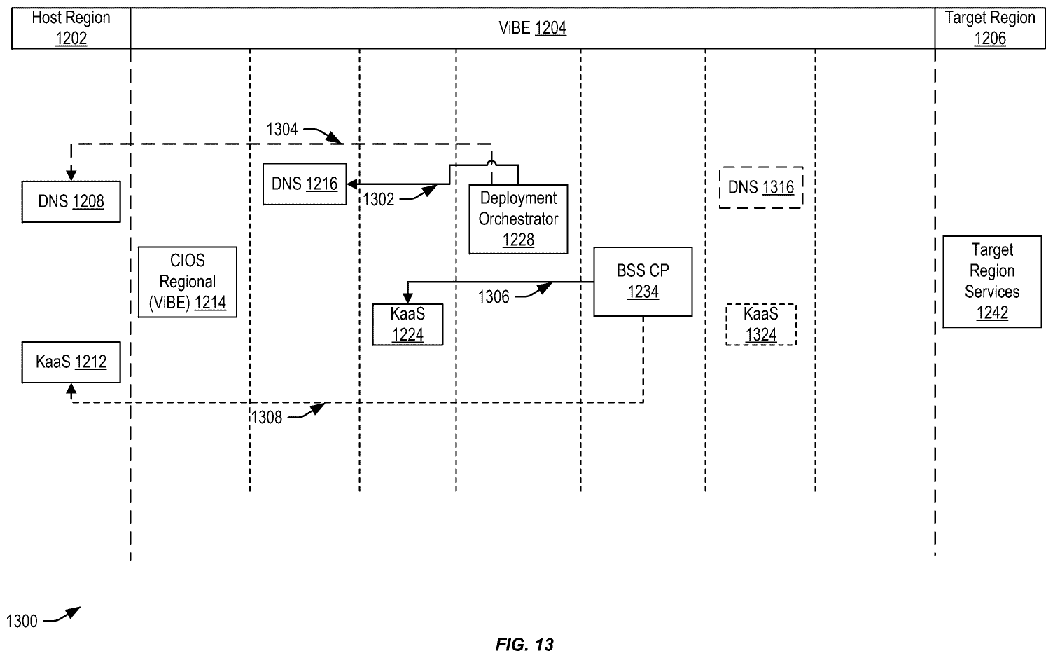

To accommodate the changed architecture, the ViBE can be modified in three ways. First, the instances of the services deployed into the ViBE can be instances of the overlay service to which they correspond. For example, the DNS service deployed into the ViBE (e.g., DNS 1312 of FIG. 13) can be an instance of the DNS service in the overlay of the host region, rather than an instance of the DNS service in the substrate. Second, constraints on the deployment order of services into the ViBE (due to dependencies) can be reduced due to the availability of a corresponding service in the overlay of the host region to support the dependent services in the ViBE. For example, services in the ViBE can depend on a functional DNS service in the ViBE, so that these dependent services may not be deployed into the ViBE until a capability is published indicating a successful deployment of the DNS service. However, rather than all dependent services waiting until the deployment of their dependency service, the services deployed into the ViBE can be configured to communicate with the corresponding service in the overlay of the host region until the dependency service has deployed into the ViBE. Third, particular services in the ViBE can be configured to act as a proxy shim for communications from services in the target region to services in the host region. During region build, the target region may be configured in a realm different from the realm of the host region. Cross-realm communication channels may be restricted, so that services in the target region may not be able to communicate with services in the host region. To enable traffic for services in the target region that require data from the host region that is not in the ViBE and not yet migrated to the target region, the services in the target region can make requests to the proxy shim in the ViBE, which can in turn communicate with a service in the host region to retrieve the requested data.

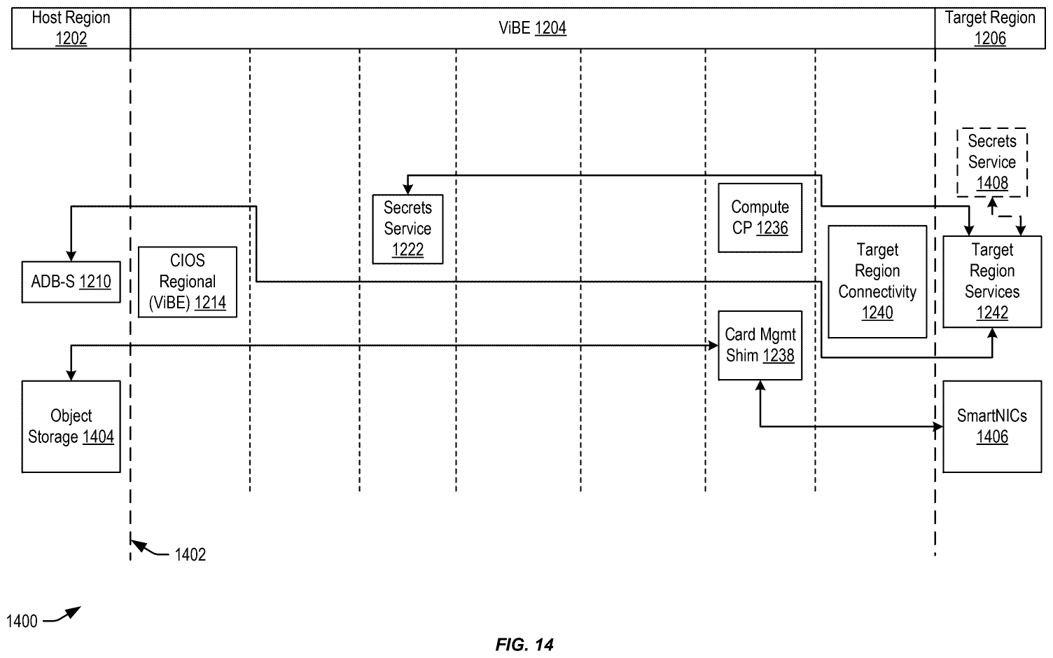

FIG. 12 is a block diagram depicting an example set of services 1200 deployed in a ViBE 1204 for building a region of a scalable footprint data center, according to some embodiments. The region of the scalable footprint data center can be target region 1206, which can be an example of target region 1434 described above with respect to FIG. 14. In some embodiments, the target region 1206 can be any region built using a ViBE. The host region 1202 and the ViBE 1204 can be examples of host region 1432 and ViBE 1416 of FIG. 14, respectively.

As depicted in FIG. 12, services can be deployed into the ViBE 1204 from left to right in an order that respects the dependencies of each service on other services to be deployed. For example, each grouping of services in the ViBE 1204 separated by a dashed line can be deployed simultaneously or nearly simultaneously. Services to the right may generally depend on services to the left in the diagram of FIG. 12, so that each group of services are deployed after the services to the left have been deployed into the ViBE 1204. For example, CIOS regional (ViBE) 1214 may be deployed first into the ViBE 1204 to perform operations for deploying the other services in the ViBE 1204, as described above in FIGS. 13 and 14. The specific order of deployment of the services can be defined in a build dependency graph like build dependency graph 1413 of FIG. 14.

The host region 1202 can include services that exist in the overlay of the host region. These services can include DNS service 1208, an autonomous database service 1210, a key-value database service 1212, as well as other services (not depicted) to support building the ViBE 1204 like CIOS regional (e.g., CIOS regional 1114) and a deployment orchestrator (e.g., deployment orchestrator 1117). The DNS service 1208 can be the DNS service configured to provide domain name resolution and domain management for the host region 1202. The autonomous database service 1210 can be a service configured to provide database access and management in the host region 1202. The key-value database service 1212 can be a service configured to provide key-value database access and management in the host region 1202.

To improve the speed of the scale out from the ViBE 1204 to the target region 1206, the autonomous database service 1210 may not be deployed to the ViBE 1204. Services in the ViBE 1204 that use an autonomous database to persist service data can use autonomous database service 1210 in the host region 1202. The persisted data can then be migrated to the target region 1206 in a separate migration process that does not rely on scaling out an instance of the autonomous database service 1210 in the ViBE 1204. Some services may use the key-value database service for persisting some service data. An instance of key-value database service 1224 can be deployed to ViBE 1204 to support these services. The data persisted by key-value database service 1224 can be sent to the target region 1206 when the key-value database service 1224 scales out from the ViBE 1204 to the target region 1206.

As described above, one of the first service that can be deployed to the VIBE 1204 can be an instance of CIOS regional (ViBE) 1214, which may be an example of CIOS regional (ViBE) 1426 of FIG. 14. Once CIOS regional (ViBE) 1214 is deployed to the ViBE 1204, an instance of the DNS service 1216 and the associated DNS control plane (CP) 1218 can be deployed. A public key infrastructure (PKI) service 1220 can be deployed to the ViBE 1204. The PKI service 1220 can be configured to perform operations for generating and vending keys and certificates and for performing corresponding cryptographic operations.

Once the DNS service 1216 has been deployed to the ViBE 1204, other services that may depend on the DNS service 1216 can be deployed to the ViBE 1204, including a secrets service 1222 and the key-value database service 1224. The secrets services 1222 can be configured to store and vend credentials (secrets) for services in the ViBE 1204 for use in performing authorization and authentication operations. The credentials can include keys, tokens, passwords, and other data used for authorization and authentication. The secrets service 1222 can persist secrets in a vault in the host region 1202 and then move those secrets to a vault in the target region 1206 when the secrets service 1222 scales out to the target region 1206. The secrets can correspond to credentials that are applicable to services in the host region 1202. The secrets can include credentials that can be used to establish secure cross-realm communication from the target region 1206 to a service in the host region 1202. For example, some services that deploy to the target region 1206 may need data that is persisted by the autonomous database service 1210 in the host region 1202. These services can use secrets service 1222 in the VIBE 1204 (or the secrets service in the target region 1206 after scale out) to obtain credentials to allow the communication from the target region 1206 to the autonomous database service 1210 in the host region 1202. Additional details about establishing cross-realm communication from the target region 1206 to the host region 1202 is provided below with respect to FIG. 14.

Subsequent groups of services can be deployed to the VIBE 1204, including identity service control plane 1226, an instance of deployment orchestrator 1228, an instance of host provisioning service 1230, and a VCN DNS service 1232. The identity control plane 1226 can be configured to perform control plane operations for an identities service in the ViBE 1204. For example, the identities service can support creation of identities resources like groups, group policies, resource identifiers, and the like in the ViBE 1204, which can persist in a corresponding identity service data plane (not pictured). The VCN DNS service 1232 can be configured to perform DNS operations for VCNs provisioned in the target region 1206 during region build operation. The host provisioning service 1230 can be configured (in conjunction with a compute service) to provision hosts (e.g., bare metal instances, hypervisors, and VMs) on infrastructure in the target region 1206 in conjunction with a compute service.

A block storage service CP 1234 and a compute service CP 1236 can be deployed to the ViBE 1204. The block storage service CP 1234 can be configured to provide block storage volumes for resources in the target region 1206. The compute service control plane 1236 can be configured to provision compute instances in the target region 1206, including VMs on hypervisors on host devices in the target region 1206.

A card management shim 1238 can also be deployed to the ViBE 1204. The card management shim 1238 can be a proxy shim that provides an API accessible from both the host region 1202 and the target region 1206 for the purposes of configuring the SmartNICs within the target region 1206. Because the host region 1202 can exist in a separate realm (having its own namespace and authorization/authentication credentials for services therein), services and other resources in the target region 1206 cannot directly pass calls to the host region 1202. In particular, the SmartNICs in the target region 1206 can require configuration data that is stored in object storage in the host region 1202. The configuration data for the SmartNICs may be needed to fully configure the SmartNICs to support VCNs in the target region 1206 early in the scale out process from the ViBE 1204 to the target region 1206. The card management shim 1238 can allow the SmartNICs to request the configuration data from the card management shim 1238, which can in turn request the data from the object storage in the host region 1202. Additional details of such “dual-legged” proxy shims for services in the ViBE 1204 are provided below with respect to FIG. 14.

A service to support network connectivity to the target region 1206 can be deployed into the ViBE 1204. The target region connectivity 1240 can include functionality for a VPN from the ViBE 1204 to the target region 1206. For example, the target region connectivity 1240 can be used to establish the tunnel 1436 of FIG. 14.

As described above, once the ViBE 1204 has been built and connected (via target region connectivity 1240), the ViBE 1204 can be used to provision infrastructure in the target region 1206 and deploy or scale out services into the target region 1206. The target region services 1242 can include a DNS service, VCN data plane, load balancers, compute service, block storage service, and the like.

FIG. 13 is a block diagram depicting a deployment order 1300 of services in the ViBE 1204, according to some embodiments. As described above, services deployed to the VIBE 1204 can be deployed in a dependency-aware manner, so that services that depend on the functionality of other services are not deployed until the other services have been deployed at publish their capabilities. However, since services now exist in the overlay of the host region 1202, the dependency constraints can be reduced so that services deployed in the ViBE 1204 can use services in the overlay of the host region 1202 until their dependency service(s) are deployed to the ViBE 1204.

As a particular example, FIG. 13 shows the deployment of an instance of the DNS service 1216. The deployment orchestrator 1228 may depend on the functionality of the DNS service 1216 in the ViBE 1204, as indicated by the communications path 1302. For example, the deployment orchestrator 1228 may use DNS service 1216 to resolve network addresses of services or other endpoints in the ViBE 1204. However, in some embodiments, deployment orchestrator 1228 can be deployed prior to DNS service 1216 being deployed and/or posting a capability to a capabilities service indicating that DNS service 1216 is operational. For example, the DNS service 1316 can be deployed after deployment orchestrator 1228. In this case, deployment orchestrator 1228 can be configured to communicate with an instance of the DNS service 1208 in the overlay of the host region 1202, as indicated by communications path 1304. Once the DNS service 1316 is deployed into the ViBE 1204, the deployment orchestrator 1228 can begin directing traffic to the DNS service 1316, rather than the instance of the DNS service 1208 in the host region 1202.

Similarly, an instance of the block storage service CP 1234 can be deployed in the ViBE 1204. The block storage service CP 1234 can depend on the key-value database service 1224, as indicated by the communications path 1306. If the key-value database service 1224 is not deployed prior to the block storage service CP 1234, and instead is deployed later as key-value database service 1324, the block storage service CP 1234 can be configured to communicate with an instance of key-value database service 1212 in the host region 1202, as indicated by the communications path 1308.

FIG. 14 is a block diagram depicting cross-realm communications 1400 in the ViBE 1204, according to some embodiments. Cross-realm communications can be achieved in at least two embodiments described herein. Cross-realm communications can refer to communications from one region (e.g., the target region 1206) to another region (e.g., the host region 1202) that cross a realm boundary (e.g., realm boundary 1402). A “realm” may be a further abstraction of a “region” that provides a logical grouping of regions including defining a realm-specific namespace for domain names and other identifiers within the regions of the realm. Because of the different namespace, domains, and other identity resources, authentication and authorization of requests and other communications to/from services spanning the realm boundary may not function normally. For example, services in the target region 1206 may obtain credentials in the target region 1206 that reference the domain of the target region 1206 and so may not be authenticatable by services in the host region 1202. In general, cross-realm communications can occur over a secure tunnel (e.g., a VPN tunnel) between the target region 1206 and the host region 1202.

In a first embodiment, a cross-realm communication channel can be established using the secrets service 1222 in the ViBE 1204. As described above with respect to FIG. 12, the secrets services 1222 can be configured to store and vend credentials (secrets) for services in the ViBE 1204 for use in performing authorization and authentication operations. The credentials can include keys, tokens, passwords, and other data used for authorization and authentication. The secrets service 1222 can persist secrets in a vault in the host region 1202 and then move those secrets to a vault in the target region 1206 when the secrets service 1222 scales out to the target region 1206, as secrets service 1408. The secrets can correspond to credentials that are applicable to services in the host region 1202. The secrets can include credentials that can be used to establish secure cross-realm communication from the target region 1206 to a service in the host region 1202.

As a particular example, a service that scales out from the ViBE 1204 to the target region 1206 (e.g., one of the target region services 1242) may have created and persisted data while in the ViBE 1204. The data may be persisted by the autonomous database service 1210. Once the service scales out to the target region 1206, but before the autonomous database has migrated to the target region 1206, the service may need to obtain the data from the autonomous database in the host region 1202. Obtaining data from the autonomous database service 1210 in the host region 1202 can require communication across the realm boundary 1402. The service can use secrets service 1222 in the ViBE 1204 to obtain credentials for establishing a cross-realm channel to obtain data from autonomous database service 1210.

In a second embodiment, a “dual-legged” cross-realm proxy can be implemented to facilitate requests and other traffic to/from services in regions spanning the realm boundary. The cross-realm proxy can be implemented as a proxy shim for a service or resource provisioned or deployed to the target region 1206. The cross-realm proxy can be deployed into the ViBE 1204 and act as a service with an API that can be reached by both services in the host region 1202 and services and/or resources in the target region 1206 (as well as services in the VIBE 1204 if applicable).

As a particular example, the card management shim 1238 can be a cross-realm proxy for SmartNICs 1406 in the target region 1206. Configuration data for the SmartNICs 1406 can be stored in object storage 1404 in the host region 1202. To configure the SmartNICs 1406 to support VCNs in the target region 1206 or other networking operations of the SmartNICs 1406, the SmartNICs 1406 (e.g., an agent or other process executing on the SmartNICs) can send a request to the card management shim 1238. The request can include credentials that are usable by the card management shim 1238 to authenticate the request. The credentials can be credentials associated with the target region 1206. If the authentication is successful, the card management shim 1238 can send a request to object storage 1404. The request from the card management shim 1238 can include credentials for the card management shim 1238 that are associated with the host region 1202. The object storage 1404 (e.g., an object storage service) can authenticate the request from the card management shim 1238 using the credentials from the card management shim 1238 and provide the requested data. The card management shim 1238 can then provide the data to the SmartNICs 1406. In some embodiments, each particular service requiring cross-realm communications can have an associated shim in the ViBE 1204.

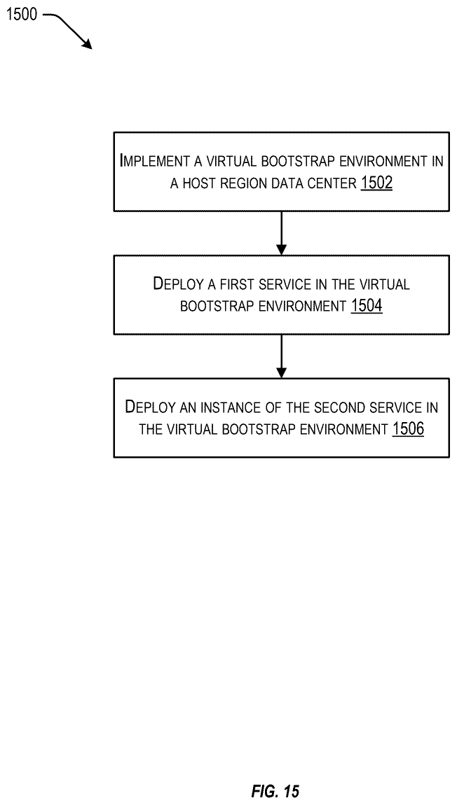

FIG. 15 is a flow diagram of an example process 1500 for deploying services to a ViBE, according to some embodiments. The process 1500 may be performed by one or more components of a computing system, including one or more components of a computing system in a host region (e.g., host region 1202). The operations of process 1500 may be performed in any suitable order, and process 1500 may include more or fewer operations than those depicted in FIG. 15.

The process 1500 can begin with the computing system implementing a virtual bootstrap environment (ViBE) in a host region data center, at block 1502. The ViBE can be an example of ViBE 1204 of FIG. 12. The ViBE can be implemented in a VCN hosted by the host region. Building the ViBE can proceed according to the processes described above with respect to FIGS. 12-11.

At block 1504, the computing system can deploy a first service in the virtual bootstrap environment. For example, a CIOS regional (ViBE) can deploy the resources of the first service to the ViBE according to steps 1-12 of FIG. 13. The first service can have a dependency on a second service. In some embodiments, the dependency on the second service can include a requirement that the second service is available to receive the service traffic from the first service. The second service may not yet be deployed to the ViBE. In some embodiments, the second service may be a domain name system (DNS) service (e.g., DNS service 1216). In some embodiments, the second service may be a database service (e.g., key-value database service 1224).

At Block 1506, the computing system can deploy an instance of the second service in the ViBE. For example, the CIOS regional (ViBE) can deploy the resources of the instance second service to the ViBE according to steps 1-12 of FIG. 13. The instance of the second service can be configured to receive service traffic from the first service after the instance of the second service is deployed in the virtual bootstrap environment. The first service can be configured to send the service traffic to a corresponding instance of the second service in the host region prior to the instance of the second service being deployed in the virtual bootstrap environment. In some embodiments, the instance of the second service is deployed in the ViBE prior to the deployment of the first service in the ViBE. In some embodiments, the instance of the second service is deployed in the ViBE after the deployment of the first service in the ViBE. For example, if the second service is a DNS service, then the first service can direct traffic from the first service to the DNS service in the host region if the DNS service has not yet been deployed to the ViBE. Once the DNS service is deployed to the ViBE, the first service can direct its service traffic to the instance of the DNS service in the ViBE.

In some embodiments, after deploying the instance of the second service in the ViBE, a capabilities service (e.g., capabilities service 1118 of FIG. 11) can receive an indication that the instance of the second service has been successfully deployed. The indication can be received from the instance of the second service. In response, the computing system can configure the first service to send the service traffic to the instance of the second service in the virtual bootstrap environment.

In some embodiments, once the first service and the second service have been deployed to the ViBE, the computing system can use the ViBE and the first service to deploy resources to an infrastructure component of a scalable footprint data center. For example, the scalable footprint data center can be an example of target region 1206 of FIG. 12. The ViBE can be used to deploy target region services to the scalable footprint data center.

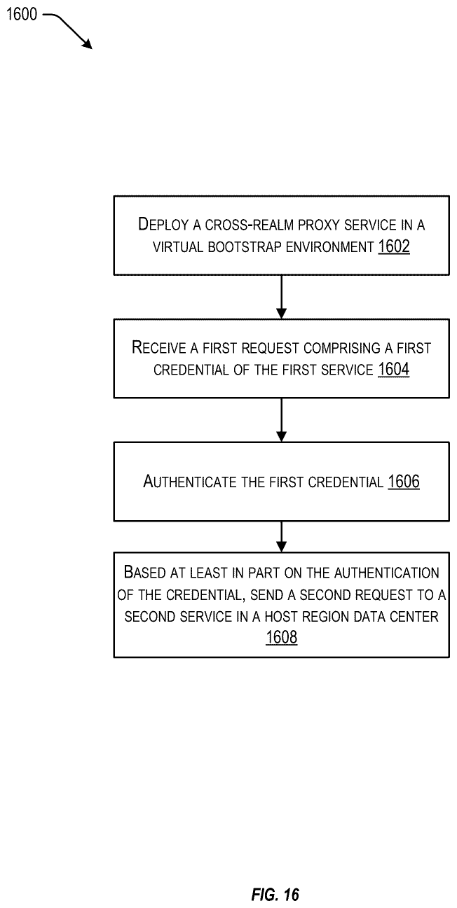

FIG. 16 is a flow diagram of an example process for enabling cross-realm traffic between a host region, a ViBE, and a region of a scalable footprint data center, according to some embodiments. The process 1600 may be performed by one or more components of a computing system, including one or more components of a computing system in a host region (e.g., host region 1202). The region of the scalable footprint data center may be an example of target regions described herein, including target region 1206 of FIG. 12. The operations of process 1600 may be performed in any suitable order, and process 1600 may include more or fewer operations than those depicted in FIG. 16.

The process 1600 may begin at block 1602, with the computing system deploying a cross-realm proxy service in a virtual bootstrap environment (ViBE). The ViBE can be an example of ViBE 1204 of FIG. 12. The ViBE can be implemented in a VCN hosted by the host region. Building the ViBE can proceed according to the processes described above with respect to FIGS. 12-11. The cross-realm proxy service can be a proxy shim comprising code executing in the ViBE that allows the cross-realm proxy to receive and send data, including requests, calls, and associated payloads, with respect to different identity domains and namespaces. For example, the target region can be in a first realm and the host region can be in a second realm. The proxy shim can provide an API accessible from both the host region and the target region. The host region can exist in a separate realm having its own namespace and authorization/authentication credentials for services therein, so that services and other resources in the target region cannot directly pass calls to the host region.

At block 1604, the cross-realm proxy service can receive a first request from a first service in a target region data center. The target region data center can be an example of the scalable footprint data center. The first request can include a first credential of the first service. For example, the first credential can include a token usable by the cross-realm proxy service to authenticate the identity of the first service. The first credential can be associated with a first namespace of the target region data center. For example, the first credential can include an identifier of the first service that includes domain information for the realm in which the target region data center is contained.

At block 1606, the cross-realm proxy service can authenticate the first credential. Authenticating the first credential can include comparing the first credential to identity information accessible to the cross-proxy service. In some embodiments, the cross-realm proxy service can communicate with an identities service in the ViBE to authenticate the first credential.

At block 1608, the cross-realm proxy service can send a second request to a second service in a host region data center. The second request can be sent based at least in part on the successful authentication of the first credential by the cross-realm proxy service. The second request can include a second credential of the cross-realm proxy service. For example, the second credential can be a credential identifying the cross-realm proxy service. The second credential can be associated with a second namespace of the host region data center.

In some embodiments, the cross-realm proxy service can receive data associated with the request from the second service. For example, the data can be data requested in the request. The cross-realm proxy service can then send the data to the first service. In some embodiments, receiving the data can be in response to the second service authenticating the second credential in the host region data center.

In some embodiments, the first service comprises a process executing on a smart network interface card in the target region data center. The data can then include configuration data for the smart network interface card. The second service can include an object storage service in the host region data center.

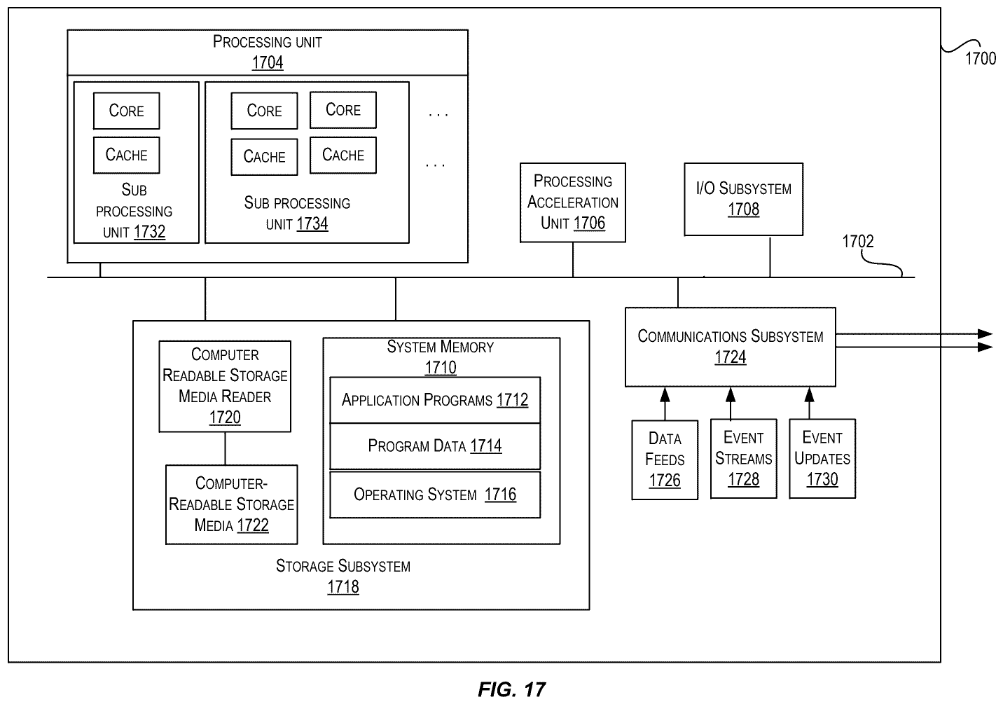

FIG. 17 illustrates an example computer system 1700, in which various embodiments may be implemented. The system 1700 may be used to implement any of the computer systems described above. As shown in the figure, computer system 1700 includes a processing unit 1704 that communicates with a number of peripheral subsystems via a bus subsystem 1702. These peripheral subsystems may include a processing acceleration unit 1706, an I/O subsystem 1708, a storage subsystem 1718 and a communications subsystem 1724. Storage subsystem 1718 includes tangible computer-readable storage media 1722 and a system memory 1710.

Bus subsystem 1702 provides a mechanism for letting the various components and subsystems of computer system 1700 communicate with each other as intended. Although bus subsystem 1702 is shown schematically as a single bus, alternative embodiments of the bus subsystem may utilize multiple buses. Bus subsystem 1702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1704, which can be implemented as one or more integrated circuits (e.g., a conventional microprocessor or microcontroller), controls the operation of computer system 1700. One or more processors may be included in processing unit 1704. These processors may include single core or multicore processors. In certain embodiments, processing unit 1704 may be implemented as one or more independent processing units 1732 and/or 1734 with single or multicore processors included in each processing unit. In other embodiments, processing unit 1704 may also be implemented as a quad-core processing unit formed by integrating two dual-core processors into a single chip.

In various embodiments, processing unit 1704 can execute a variety of programs in response to program code and can maintain multiple concurrently executing programs or processes. At any given time, some or all of the program code to be executed can be resident in processor(s) 1704 and/or in storage subsystem 1718. Through suitable programming, processor(s) 1704 can provide various functionalities described above. Computer system 1700 may additionally include a processing acceleration unit 1706, which can include a digital signal processor (DSP), a special-purpose processor, and/or the like.

I/O subsystem 1708 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1700 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1700 may comprise a storage subsystem 1718 that provides a tangible non-transitory computer-readable storage medium for storing software and data constructs that provide the functionality of the embodiments described in this disclosure. The software can include programs, code, instructions, scripts, etc., that when executed by one or more cores or processors of processing unit 1704 provide the functionality described above. Storage subsystem 1718 may also provide a repository for storing data used in accordance with the present disclosure.

As depicted in the example in FIG. 17, storage subsystem 1718 can include various components including a system memory 1710, computer-readable storage media 1722, and a computer readable storage media reader 1720. System memory 1710 may store program instructions that are loadable and executable by processing unit 1704 as application programs 1712. System memory 1710 may also store data 1714 that is used during the execution of the instructions and/or data that is generated during the execution of the program instructions. Various different kinds of programs may be loaded into system memory 1710 including but not limited to client applications, Web browsers, mid-tier applications, relational database management systems (RDBMS), virtual machines, containers, etc.

System memory 1710 may also store an operating system 1716. Examples of operating system 1716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1700 executes one or more virtual machines, the virtual machines along with their guest operating systems (GOSs) may be loaded into system memory 1710 and executed by one or more processors or cores of processing unit 1704.

System memory 1710 can come in different configurations depending upon the type of computer system 1700. For example, system memory 1710 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1710 may include a basic input/output system (BIOS) containing basic routines that help to transfer information between elements within computer system 1700, such as during start-up.

Computer-readable storage media 1722 may represent remote, local, fixed, and/or removable storage devices plus storage media for temporarily and/or more permanently containing, storing, computer-readable information for use by computer system 1700 including instructions executable by processing unit 1704 of computer system 1700.

Computer-readable storage media 1722 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1722 may include, but is not limited to, Zip® drives, flash memory cards, universal serial bus (USB) flash drives, secure digital (SD) cards, DVD disks, digital video tape, and the like. Computer-readable storage media 1722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1700.

Machine-readable instructions executable by one or more processors or cores of processing unit 1704 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to connect to one or more devices via the Internet. In some embodiments communications subsystem 1724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1724 can provide wired network connectivity (e.g., Ethernet) in addition to or instead of a wireless interface.

In some embodiments, communications subsystem 1724 may also receive input communication in the form of structured and/or unstructured data feeds 1726, event streams 1728, event updates 1730, and the like on behalf of one or more users who may use computer system 1700.

By way of example, communications subsystem 1724 may be configured to receive data feeds 1726 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1724 may also be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1724 may also be configured to output the structured and/or unstructured data feeds 1726, event streams 1728, event updates 1730, and the like to one or more databases that may be in communication with one or more streaming data source computers coupled to computer system 1700.

Computer system 1700 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
implementing, by a computing system, a virtual bootstrap environment in a host region data center;
deploying, by the computing system, a first service in the virtual bootstrap environment, the first service having a dependency on a second service; and
deploying, by the computing system, an instance of the second service in the virtual bootstrap environment, the instance of the second service configured to receive service traffic from the first service after the instance of the second service is deployed in the virtual bootstrap environment, and the first service being configured to send the service traffic to a corresponding instance of the second service in the host region prior to the instance of the second service being deployed in the virtual bootstrap environment.

2. The method of claim 1, wherein the second service is a domain name system (DNS) service.

3. The method of claim 1, wherein the second service is a database service.

4. The method of claim 1, wherein the instance of the second service is deployed in the virtual bootstrap environment prior to the deployment of the first service in the virtual bootstrap environment.

5. The method of claim 1, wherein the instance of the second service is deployed in the virtual bootstrap environment after the deployment of the first service in the virtual bootstrap environment.

6. The method of claim 1, further comprising:
after deploying the instance of the second service in the virtual bootstrap environment, receiving, by a capabilities service of the computing system from the instance of the second service, an indication that the instance of the second service has been successfully deployed; and
responsive to the indication, configuring, by the computing system, the first service to send the service traffic to the instance of the second service in the virtual bootstrap environment.

7. The method of claim 1, further comprising deploying, by the computing system and using the first service, resources to an infrastructure component of a scalable footprint data center.

8. The method of claim 1, wherein the dependency on the second service comprises a requirement that the second service is available to receive the service traffic from the first service.

9. A computing system comprising:
one or more processors; and
one or more memories storing computer-executable instructions that, when executed by the one or more processors, cause the computing system to at least:
implement a virtual bootstrap environment in a host region data center;
deploy a first service in the virtual bootstrap environment, the first service having a dependency on a second service; and
deploy an instance of the second service in the virtual bootstrap environment, the instance of the second service configured to receive service traffic from the first service after the instance of the second service is deployed in the virtual bootstrap environment, and the first service being configured to send the service traffic to a corresponding instance of the second service in the host region prior to the instance of the second service being deployed in the virtual bootstrap environment.

10. The computing system of claim 9, wherein the second service is a domain name system (DNS) service.

11. The computing system of claim 9, wherein the second service is a database service.

12. The computing system of claim 9, wherein the instance of the second service is deployed in the virtual bootstrap environment prior to the deployment of the first service in the virtual bootstrap environment.

13. The computing system of claim 9, wherein the instance of the second service is deployed in the virtual bootstrap environment after the deployment of the first service in the virtual bootstrap environment.

14. The computing system of claim 9, wherein the one or more memories comprise additional instructions that, when executed by the one or more processors, cause the computing system to further:
after deploying the instance of the second service in the virtual bootstrap environment, receive, by a capabilities service of the computing system from the instance of the second service, an indication that the instance of the second service has been successfully deployed; and
responsive to the indication, configure the first service to send the service traffic to the instance of the second service in the virtual bootstrap environment.

15. The computing system of claim 9, wherein the dependency on the second service comprises a requirement that the second service is available to receive the service traffic from the first service.

16. A non-transitory computer-readable medium storing instructions that, when executed by one or more processors of a computing system, cause the computing system to at least:
implement a virtual bootstrap environment in a host region data center;
deploy a first service in the virtual bootstrap environment, the first service having a dependency on a second service; and
deploy an instance of the second service in the virtual bootstrap environment, the instance of the second service configured to receive service traffic from the first service after the instance of the second service is deployed in the virtual bootstrap environment, and the first service being configured to send the service traffic to a corresponding instance of the second service in the host region prior to the instance of the second service being deployed in the virtual bootstrap environment.

17. The non-transitory computer-readable medium of claim 16, wherein the second service is a domain name system (DNS) service.

18. The non-transitory computer-readable medium of claim 16, wherein the second service is a database service.

19. The non-transitory computer-readable medium of claim 16 wherein the instance of the second service is deployed in the virtual bootstrap environment prior to the deployment of the first service in the virtual bootstrap environment.

20. The non-transitory computer-readable medium of claim 16, wherein the instance of the second service is deployed in the virtual bootstrap environment after the deployment of the first service in the virtual bootstrap environment.
